(19) United States
(12) Patent Application Publication
(10) Pub. No.: US 2019/0146268 A1
(43) Pub. Date: May 16, 2019

(54) DISPLAY DEVICE

(71) Applicant: Japan Display Inc., Tokyo (JP)

(72) Inventors: Tatsuya YATA, Tokyo (JP); Kazunari TOMIZAWA, Tokyo (JP)

(21) Appl. No.: 16/187,000

(22) Filed: Nov. 12, 2018

(30) Foreign Application Priority Data
Nov. 14, 2017 (JP) 2017-219282

(51) Int. Cl. G02F 1/1335; G02F 1/1343

(52) U.S. Cl. CPC G02F 1/133514; G02F 1/133553; G09G 3/3607; G09G 2320/0242; G02F 2201/52; G02F 1/13439

(57) ABSTRACT

According to an aspect, a display device includes: first to fourth sub-pixels including respective first to fourth color filters transmitting light having a spectrum peak falling on respective spectra of reddish green, bluish green, red, and blue. The first to fourth sub-pixels each include a reflective electrode reflecting light transmitted through the corresponding color filter. The first sub-pixel is adjacent to the third sub-pixel in a first direction. The second sub-pixel is adjacent to the fourth sub-pixel in the first direction. The first sub-pixel is adjacent to the second sub-pixel in a second direction. The first sub-pixel is not adjacent to the third sub-pixel in the second direction. The first sub-pixel is not adjacent to the fourth sub-pixel in the second direction. The second sub-pixel is not adjacent to the third sub-pixel in the second direction. The second sub-pixel is not adjacent to the fourth sub-pixel in the second direction.

### CROSS-REFERENCE TO RELATED APPLICATIONS

This application claims priority from Japanese Application No. 2017-219282, filed on Nov. 14, 2017, the contents of which are incorporated by reference herein in its entirety.

### BACKGROUND

### 1. Technical Field

The present disclosure relates to a display device.

### 2. Description of the Related Art

As disclosed in Japanese Patent Application Laid-open Publication No. 2010-97176, a reflective display device that reflects external light to display a color image has been known.

The reflective display device typically combines light reflected from sub-pixels of red (R), green (G), and blue (B) to output light having a color other than the foregoing colors. However, yellow obtained by combining reflected light in red (R) and green (G) looks dingy, and obtaining required luminance and saturation has been a difficult task to achieve.

For the foregoing reasons, there is a need for a display device that can enhance the luminance and saturation of yellow.

### SUMMARY

According to an aspect, a display device includes: a plurality of first sub-pixels each including a first color filter that transmits light having a spectrum peak falling on a spectrum of reddish green; a plurality of second sub-pixels each including a second color filter that transmits light having a spectrum peak falling on a spectrum of bluish green; a plurality of third sub-pixels each including a third color filter that transmits light having a spectrum peak falling on a spectrum of red; and a plurality of fourth sub-pixels each including a fourth color filter that transmits light having a spectrum peak falling on a spectrum of blue. The first sub-pixels, the second sub-pixels, the third sub-pixels, and the fourth sub-pixels each include a reflective electrode that reflects light transmitted through the corresponding color filter. One of the first sub-pixels is adjacent to one of the third sub-pixels in a first direction. One of the second sub-pixels is adjacent to one of the fourth sub-pixels in the first direction. The one of the first sub-pixels is adjacent to the one of the second sub-pixels in a second direction crossing the first direction. None of the first sub-pixels is adjacent to the third sub-pixels in the second direction. None of the first sub-pixels is adjacent to the fourth sub-pixels in the second direction. None of the second sub-pixels is adjacent to the third sub-pixels in the second direction. None of the second sub-pixels is adjacent to the fourth sub-pixels in the second direction.

### BRIEF DESCRIPTION OF THE DRAWINGS

FIG. 1 is a perspective view schematically illustrating a major configuration of a single sub-pixel;

FIG. 2 is a graph indicating exemplary spectra of red, reddish green, green, bluish green, and blue;

FIG. 3 is a diagram illustrating exemplary shapes of sub-pixels included in a display device, an exemplary positional relation among the sub-pixels, and exemplary color filters of the respective sub-pixels;

FIG. 4 is a chart indicating relations among reproduced colors by the sub-pixels in an embodiment, input gradation values as image signals constituting an input image, and the sub-pixels used for the output;

FIG. 5 is a chart indicating a schematic chromaticity diagram (xy chromaticity diagram) that represents a correspondence between yellow reproduced by the display device in the embodiment and the peaks of spectra of light transmitted through the color filter, the chromaticity diagram being plotted within chromaticity coordinates (xy chromaticity coordinates);

FIG. 6 is a chart indicating exemplary color reproducibility of the embodiment and that of a comparative example in an L*a*b* color space;

FIG. 7 is a chromaticity diagram schematically illustrating a relation between ranges of colors that can be reproduced with a first sub-pixel, a third sub-pixel, and a fourth sub-pixel and ranges of colors that can be reproduced with a second sub-pixel, the third sub-pixel, and the fourth sub-pixel;

FIG. 8 is a diagram schematically illustrating exemplary sub-pixel rendering to be performed in color reproduction by a pixel including the first sub-pixel, the third sub-pixel, and the fourth sub-pixel, and a pixel including the second sub-pixel, the third sub-pixel, and the fourth sub-pixel;

FIG. 9 is a diagram illustrating exemplary shapes of sub-pixels that are different from the sub-pixels illustrated in FIG. 3, an exemplary positional relation among the sub-pixels, and exemplary color filters of the respective sub-pixels;

FIG. 10 is a diagram schematically illustrating exemplary sub-pixel rendering to be performed in color reproduction by a pixel including the first sub-pixel, the second sub-pixel, and the third sub-pixel, and a pixel including the first sub-pixel, the second sub-pixel, and the fourth sub-pixel;

FIG. 11 is a diagram illustrating exemplary shapes of sub-pixels that are different from the sub-pixels illustrated in FIGS. 3 and 9, an exemplary positional relation among the sub-pixels, and exemplary color filters of the respective sub-pixels;

FIG. 12 is a diagram illustrating exemplary shapes of sub-pixels that are different from the sub-pixels illustrated in FIGS. 3, 9, and 11, an exemplary positional relation among the sub-pixels, and exemplary color filters of the respective sub-pixels;

FIG. 13 is a diagram schematically illustrating exemplary sub-pixel rendering to be performed in color reproduction by a pixel including the first sub-pixel and the third sub-pixel, and a pixel including the second sub-pixel and the fourth sub-pixel;

FIG. 14 is a diagram illustrating an example of dividing each sub-pixel into a plurality of regions having different areas for area coverage modulation;

FIG. 15 is a diagram illustrating an exemplary circuit configuration of the display device;

FIG. 16 is a diagram illustrating an exemplary multiplexer for a configuration of a single pixel including three sub-pixels;

FIG. 17 is a diagram illustrating an exemplary multiplexer for a configuration of a single pixel including two sub-pixels;

FIG. 18 is a cross-sectional view schematically illustrating a sub-divided pixel;

FIG. 19 is a block diagram illustrating an exemplary circuit configuration of the pixel employing a memory in pixel (MIP) technology;

FIG. 20 is a timing chart for explaining an operation of the pixel employing the MIP technology;

FIG. 21 is a block diagram illustrating an exemplary configuration of a signal processing circuit; and

FIG. 22 is a diagram schematically illustrating an exemplary relation among external light, reflected light, and user's viewpoints when a plurality of display devices are disposed in juxtaposition.

### DETAILED DESCRIPTION

Modes (embodiments) for carrying out the present disclosure will be described below in detail with reference to the drawings. The disclosure is given by way of example only, and various changes made without departing from the spirit of the disclosure and easily conceivable by those skilled in the art naturally fall within the scope of the present disclosure. The drawings may possibly illustrate the width, the thickness, the shape, and other elements of each unit more schematically than the actual aspect to simplify the explanation. These elements, however, are given by way of example only and are not intended to limit interpretation of the present disclosure. In the specification and the drawings, components similar to those previously described with reference to a preceding drawing are denoted by like reference numerals, and overlapping explanation thereof will be appropriately omitted. In this disclosure, when an element A is described as being “on” another element B, the element A can be directly on the other element B, or there can be one or more elements between the element A and the other element B.

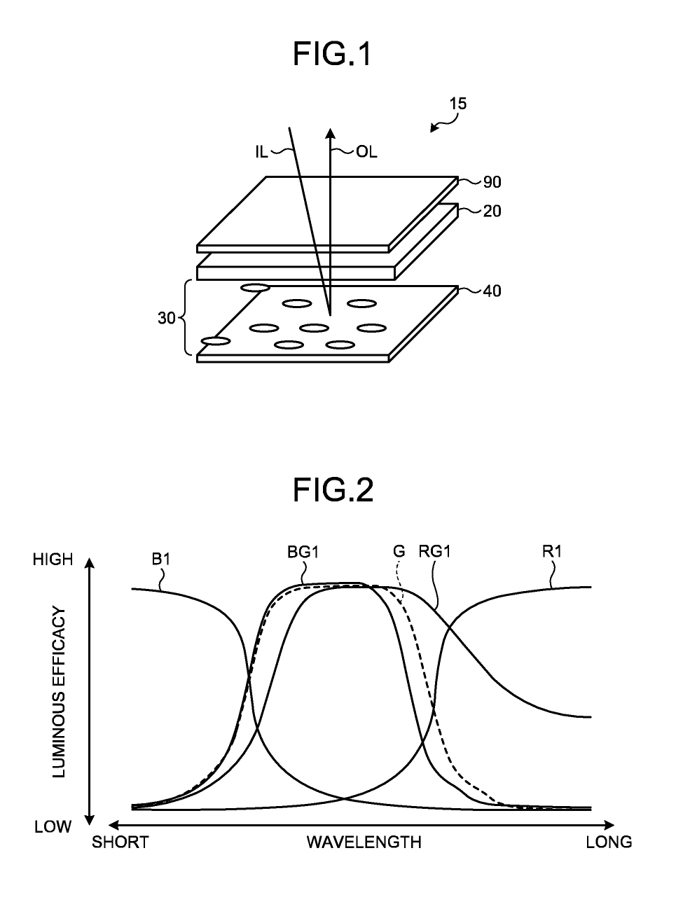

FIG. 1 is a perspective view schematically illustrating a main configuration of a single sub-pixel 15. FIG. 2 is a graph indicating exemplary spectra of red, reddish green, green, bluish green, and blue. The sub-pixel 15 includes a color filter 20 and a reflective electrode 40, for example. The color filter 20 has light transmissivity. The color filter 20 has a predetermined peak of a spectrum of light OL to be transmitted out of external light IL. Specifically, the peak of the spectrum of the light OL to be transmitted through the color filter 20 falls on either one of the spectrum of reddish green (e.g., red green RG1), the spectrum of bluish green (e.g., blue green BG1), the spectrum of red (e.g., red R1), and the spectrum of blue (e.g., blue B1). The reflective electrode 40 reflects the light OL that is transmitted through the color filter 20. As exemplified in FIG. 2, the peak of the spectrum of the red green RG1 and the peak of the spectrum of the blue green BG1 each have a portion overlapping with the peak of the spectrum of light viewed as green G. The spectrum of the red green RG1 is closer to the spectrum of the red R1 (on the long wavelength side) than the spectrum of the blue green BG1 and the spectrum of the green G are. The spectrum of the blue green BG1 is closer to the spectrum of the blue B1 (on the short wavelength side) than the spectrum of the red green RG1 and the spectrum of the green G are.

A liquid crystal layer 30 is disposed between the color filter 20 and the reflective electrode 40. The liquid crystal layer 30 includes a multitude of liquid crystal molecules. The liquid crystal molecules each have an orientation varied according to an electric field applied thereto by the reflective electrode 40, for example. The liquid crystal molecule varies a degree of transmission of the light OL that passes between the color filter 20 and the reflective electrode 40 according to the orientation. A light modulation layer 90 may be disposed on the opposite side of the liquid crystal layer 30 with the color filter 20 interposed therebetween. The light modulation layer 90 modulates, for example, a scattering direction of the light OL from the reflective electrode 40 side.

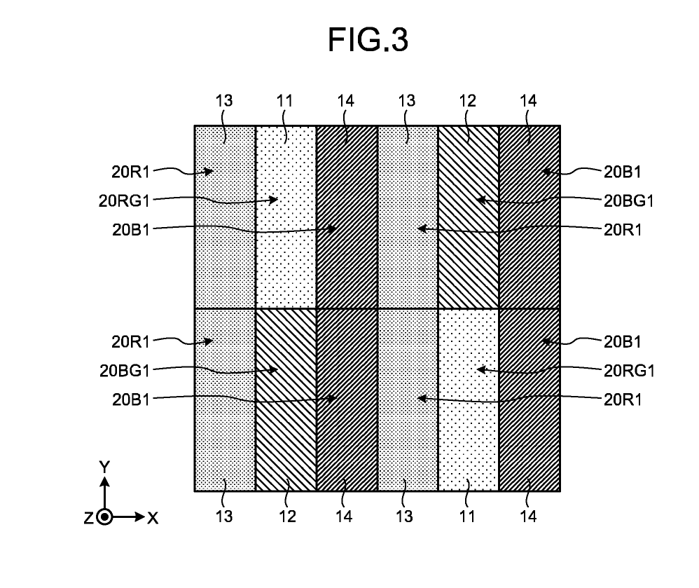

FIG. 3 is a diagram illustrating exemplary shapes of the sub-pixels 15 included in a display device, an exemplary positional relation among the sub-pixels 15, and exemplary color filters 20 of the respective sub-pixels 15. The display device includes a plurality of first sub-pixels 11, a plurality of second sub-pixels 12, a plurality of third sub-pixels 13, and a plurality of fourth sub-pixels 14. The first sub-pixels 11 each include a first color filter 20RG1. The second sub-pixels 12 each include a second color filter 20BG1. The third sub-pixels 13 each include a third color filter 20R1. The fourth sub-pixels 14 each include a fourth color filter 20B1. The peak of the spectrum of the light transmitted through the first color filter 20RG1 falls on the spectrum of the reddish green (red green RG1). The peak of the spectrum of the light transmitted through the second color filter 20BG1 falls on the spectrum of the bluish green (blue green BG1). The peak of the spectrum of the light transmitted through the third color filter 20R1 falls on the spectrum of the red (red R1). The peak of the spectrum of the light transmitted through the fourth color filter 20B1 falls on the spectrum of the blue (blue B1). The pixel has a square shape in a plan view, and includes the sub-pixels in the respective four colors in respective regions obtained by sectioning the square pixel region. The sub-pixels each have a square or rectangular shape in a plan view (hereinafter referred to as a rectangle). The four rectangles are combined to form the square pixel. A light shielding layer such as a black matrix may be disposed in regions between the sub-pixels and an outer edge of the pixel, but this light shielding layer occupies only a small region of the pixel area. Thus, when describing the shapes or combination of the sub-pixels or the shape of the pixel, such a light shielding layer may be substantially disregarded as a linear object constituting an outer edge (side) of the pixel or the sub-pixel.

In the following description, the term “color filter 20” will be used to describe the color filter 20 when the peak of the spectrum of the light OL to be transmitted is not differentiated. When the peak of the spectrum of the light OL to be transmitted is differentiated, the color filter 20 will be described as, for example, the first color filter 20RG1, the second color filter 20BG1, the third color filter 20R1, or the fourth color filter 20B1, where appropriate. The light OL that has been transmitted through the color filter 20 is viewed as light in the color corresponding to the peak of the spectrum of the light to be transmitted through the color filter 20. The term “sub-pixel 15” will be used when the sub-pixel 15 is not differentiated among the first sub-pixel 11, the second sub-pixel 12, the third sub-pixel 13, and the fourth sub-pixel 14, for example, by the colors of the color filters 20 included in the respective sub-pixels 15. The first sub-pixel 11, the second sub-pixel 12, the third sub-pixel 13, and the fourth sub-pixel 14 each include the reflective electrode 40 as illustrated in FIG. 1, which is omitted in FIG. 3.

In the description to be made with reference to FIG. 3, for example, a first direction out of directions in which the sub-pixels 15 are juxtaposed is referred to as an X-direction. A second direction orthogonal to the X-direction out of the directions in which the sub-pixels 15 are juxtaposed is referred to as a Y-direction. A direction orthogonal to both the X-direction and the Y-direction is referred to as a Z-direction. Additionally, the term “sub-pixel row”, as used herein, refers to the sub-pixels 15 juxtaposed along the X-direction. The term “sub-pixel column”, as used herein, refers to the sub-pixels 15 juxtaposed along the Y-direction. The present disclosure may employ a configuration in which the X-direction and the Y-direction cross each other at a non-right angle.

In the example illustrated in FIG. 3, the sub-pixels 15 each have a rectangular shape, a longitudinal direction of which is the Y-direction. This, however, represents an illustrative shape of the sub-pixel 15 in an X-Y plane and may be changed as appropriate.

In the display device in the embodiment, as illustrated in FIG. 3, a first one of the first sub-pixels 11 is adjacent to a first one of the third sub-pixels 13 in the X-direction. A first one of the second sub-pixels 12 is adjacent to a first one of the fourth sub-pixels 14 in the X-direction. The first one of the first sub-pixels 11 is adjacent to the first one of the second sub-pixels 12 in the Y-direction. None of the first sub-pixels 11 is adjacent to any of the third sub-pixels 13 in the Y-direction. None of the first sub-pixels 11 is adjacent to any of the fourth sub-pixels 14 in the Y-direction. None of the second sub-pixels 12 is adjacent to any of the third sub-pixels 13 in the Y-direction. None of the second sub-pixels 12 is adjacent to any of the fourth sub-pixels 14 in the Y-direction.

In the example illustrated in FIG. 3, the first one of the first sub-pixels 11 is adjacent to a second one of the fourth sub-pixels 14 in the X-direction. The first one of the second sub-pixels 12 is adjacent to a second one of the third sub-pixels 13 in the X-direction. None of the first sub-pixels 11 is adjacent to any of the second sub-pixels 12 in the X-direction.

In the example illustrated in FIG. 3, the first one of the third sub-pixels 13 is adjacent to a third one of the fourth sub-pixels 14 that is different from the first one and the second one of the fourth sub-pixels 14 in the X-direction. In the example illustrated in FIG. 3, a region formed by combining three out of the first sub-pixel 11, the second sub-pixel 12, the third sub-pixel 13, and the fourth sub-pixel 14 has a square shape. Specifically, a region formed by combining three consecutive sub-pixels 15 in the X-direction has a square shape. A plurality of sub-pixels 15 included in such a square region may serve as one pixel.

In the example illustrated in FIG. 3, an array of the third sub-pixel 13, one of the first sub-pixel 11 and the second sub-pixel 12, the fourth sub-pixel 14, the third sub-pixel 13, the other of the first sub-pixel 11 and the second sub-pixel 12, and the fourth sub-pixel 14 placed in juxtaposition is repeated in the pixel row. An array of pixel columns in the X-direction is as follows: a pixel column in which the third sub-pixels 13 are consecutively arranged in the Y-direction; a pixel column in which one of the first sub-pixel 11 and the second sub-pixel 12 and the other of the first sub-pixel 11 and the second sub-pixel 12 are alternately arranged in the Y-direction; and a pixel column in which the fourth sub-pixels 14 are consecutively arranged in the Y-direction.

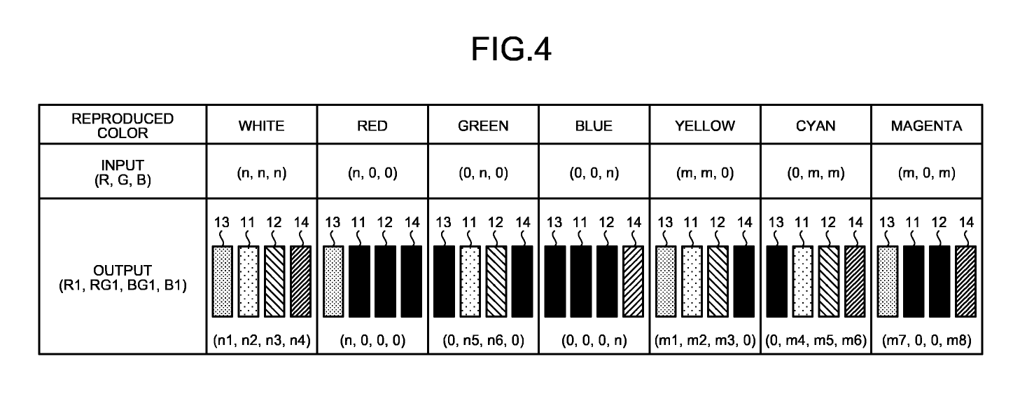

FIG. 4 is a chart indicating relations among reproduced colors by the sub-pixels in the embodiment, input gradation values as image signals constituting an input image, and the sub-pixels 15 used for the output. When the input gradation values of R, G, and B (hereinafter, the input gradation values) as image signals constituting an input image are expressed as (R, G, B)=(n, n, n), the reproduced color is white and the first sub-pixel 11, the second sub-pixel 12, the third sub-pixel 13, and the fourth sub-pixel 14 are used for the output. When the input gradation values are expressed as (R, G, B)=(n, 0, 0), the reproduced color is red and the third sub-pixel 13 is used for the output. When the input gradation values are expressed as (R, G, B)=(0, n, 0), the reproduced color is green and the first sub-pixel 11 and the second sub-pixel 12 are used for the output. When the input gradation values are expressed as (R, G, B)=(0, 0, n), the reproduced color is blue and the fourth sub-pixel 14 is used for the output. When the input gradation values are expressed as (R, G, B)=(m, m, 0), the reproduced color is yellow and the first sub-pixel 11, the second sub-pixel 12, and the third sub-pixel 13 are used for the output. When the input gradation values are expressed as (R, G, B)=(0, m, m), the reproduced color is cyan and the first sub-pixel 11, the second sub-pixel 12, and the fourth sub-pixel 14 are used for the output. When the input gradation values are expressed as (R, G, B)=(m, 0, m), the reproduced color is magenta and the third sub-pixel 13 and the fourth sub-pixel 14 are used for the output. In this manner, the display device in the embodiment reproduces yellow through the combination of the first sub-pixel 11, the second sub-pixel 12, and the third sub-pixel 13. The display device in the embodiment reproduces green through the combination of the first sub-pixel 11 and the second sub-pixel 12. The display device in the embodiment reproduces cyan through the combination of the first sub-pixel 11, the second sub-pixel 12, and the fourth sub-pixel 14. The display device in the embodiment reproduces magenta through the combination of the third sub-pixel 13 and the fourth sub-pixel 14. The display device in the embodiment reproduces red using the third sub-pixel 13. The display device in the embodiment reproduces blue using the fourth sub-pixel 14.

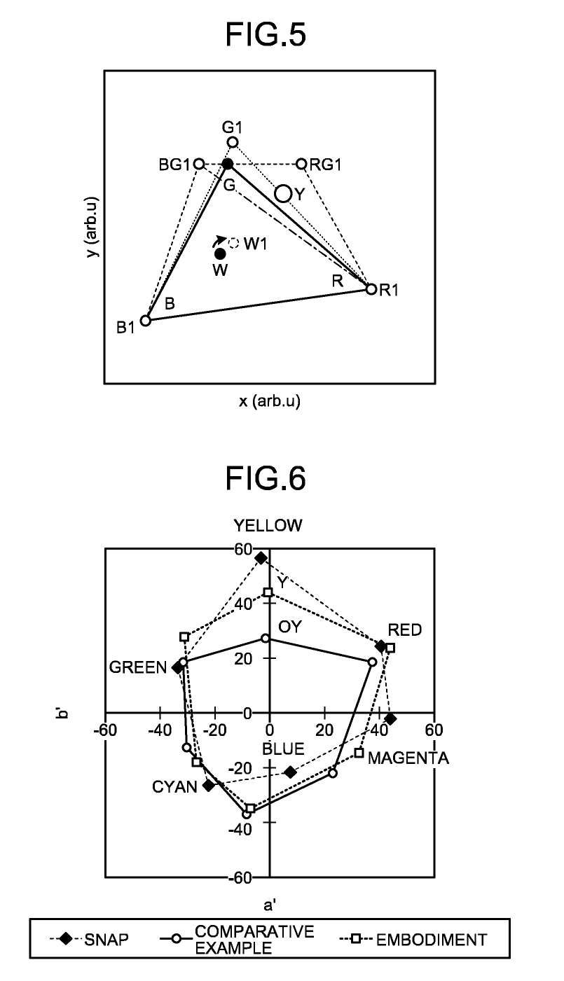

FIG. 5 is a chart indicating a schematic chromaticity diagram (xy chromaticity diagram) that represents a correspondence between yellow reproduced by the display device in the embodiment and the peaks of spectra of the light OL transmitted through the color filter 20, the chromaticity diagram being plotted within chromaticity coordinates (xy chromaticity coordinates). The chromaticity diagram indicates Y for yellow Y having predetermined luminance and saturation required for the display device. Furthermore, a color space indicating colors that can be reproduced by sub-pixels of respective three colors of the conventional red (R), conventional green (G), and conventional blue (B) included in the conventional display device is indicated by the solid-line triangle having three vertexes of R, G, and B in FIG. 5. Such a conventional display device cannot reproduce the yellow Y. With a reflective display device, in particular, the size of the color space to be reproduced on a display surface is smaller than that in a transmissive display device. The luminance and saturation of yellow to be reproduced by the conventional display device having a small color space formed with R, G, and B, are unable to exceed luminance and saturation on a straight line connecting the conventional red (R) and the conventional green (G) with respect to a white point (W). As a result, the conventional display device lacks in at least either one of luminance and saturation when reproducing the yellow Y. Even when the conventional display device includes sub-pixels of four colors, i.e., white (W) in addition to the conventional red (R), the conventional green (G), and the conventional blue (B), increasing saturation of the yellow Y using the sub-pixel of white (W) is a difficult task to achieve.

Trying to reproduce the yellow Y using the sub-pixels of three colors by the conventional technology requires the conventional red (R) and the conventional green (G) to be shifted to red (e.g., R1) and green (e.g., G1) that can reproduce the yellow Y. However, the foregoing shifting involves shifting of the white point (W) toward the yellow Y. Specifically, in the conventional display device having this type of color shifting, a color reproduced by lighting all the sub-pixels (specifically, white) is tinged with yellow as a whole, resulting in changing color reproducibility. FIG. 5 schematically indicates the white point (W) before being shifted toward the yellow Y using a black dot. FIG. 5 further indicates the white point after having been shifted toward the yellow Y using a blank dot outlined by the broken line and denoted as W1. Setting the red (e.g., R1) and the green (e.g., G1) by targeting the reproduction of the yellow Y means to further darken these colors, and reduce light transmission efficiency of the color filter 20 and luminance, resulting in dark yellow.

An approach is conceivable in which the yellow sub-pixel is added to the pixel of the conventional display device to thereby achieve the luminance and saturation compatible with the yellow Y. This approach still causes the color reproduced by lighting all the sub-pixels to be tinged with yellow as a whole, resulting in changing color reproducibility.

In the display device according to the embodiment, on the other hand, the first sub-pixel 11 includes the first color filter 20RG1 and the second sub-pixel 12 includes the second color filter 20BG1. The peak of the spectrum of the light transmitted through the first color filter 20RG1 falls on the spectrum of the reddish green (first red green RG1). The peak of the spectrum of the light transmitted through the second color filter 20BG1 falls on the spectrum of the bluish green (first blue green BG1). The peak of the spectrum of the light transmitted through the third color filter 20R1 falls on the spectrum of the red (red R1). The peak of the spectrum of the light transmitted through the fourth color filter 20B1 falls on the spectrum of the blue (blue B1). More specifically, by representing the peak of the spectrum of the light that passes through the first color filter on the chromaticity coordinates (RG1 in FIG. 5), the x-coordinate of the peak is between the x-coordinate of the white point and the x-coordinate of the red (R1 in FIG. 5) corresponding to the third color filter 20R1. Similarly, by representing the peak of the spectrum of the light that passes through the second color filter on the chromaticity coordinates (BG1 in FIG. 5), the x-coordinate of the peak is between the x-coordinate of the white point and the x-coordinate of the blue (B1 in FIG. 5) corresponding to the fourth color filter 20B1. Thus, the embodiment obtains a blue component through the second sub-pixel 12 and the fourth sub-pixel 14, thereby preventing the white point (W) from being shifted toward the yellow Y. The embodiment reproduces yellow through the combination of the first sub-pixel 11, the second sub-pixel 12, and the third sub-pixel 13. Specifically, the peaks of the spectra of light transmitted through the first color filter 20RG1, the second color filter 20BG1, and the third color filter 20R1, respectively, are set such that a combined color of the red green RG1, the blue green BG1, and the red R1 is the yellow Y. This configuration allows the yellow Y to be reproduced using the three sub-pixels 15 out of the four sub-pixels 15. Thus, the embodiment allows the region of the sub-pixels 15 used for reproducing the yellow Y to be easily increased as compared with a case in which two colors (R and G) are used out of the sub-pixels of three colors of the conventional red (R), the conventional green (G), and the conventional blue (B). Specifically, the embodiment allows a wider region encompassing the first sub-pixel 11, the second sub-pixel 12, and the third sub-pixel 13 to be easily allocated to the reproduction of the yellow Y, thereby more reliably achieving the luminance and the saturation of the yellow Y. Furthermore, the embodiment also enhances the luminance and the saturation of cyan. Additionally, as compared with a configuration that includes a sub-pixel corresponding to white (W), the embodiment allows the third sub-pixel 13 including the third color filter 20R1 corresponding to the red (R1) to be easily enlarged, thereby enhancing the reproducibility of the primary colors.

The embodiment allows the light transmission efficiency of the first color filter 20RG1 having the peak of the spectrum of light falling on the spectrum of the reddish green (e.g., red green RG1) to be easily increased. Thus, the embodiment uses the first sub-pixel 11 including the first color filter 20RG1 for the reproduction of the yellow Y, thereby more reliably achieving the luminance and the saturation of the yellow Y.

In the display device including the reflective electrode 40 such as the display device in the embodiment, a reflection factor and contrast of the light OL by the reflective electrode 40 remain constant. Meanwhile, the visual quality of colors of an image output by the display device depends on the light source color and luminous intensity of the external light IL. Thus, when the external light IL is obtained under a bright environment, for example, the visual quality of colors of the image tends to be good. In contrast, when the external light IL is obtained under a dark environment, it is relatively difficult to exhibit reliable visibility. The color filter 20 does not completely transmit the external light IL regardless of the peak of the spectrum of the light OL to be transmitted, and absorbs at least part of the external light IL. Trying to darken the reproduced color using the color filter 20 increases a ratio of an absorbed part of the external light IL. Thus, the display device that outputs an image through reflection of the light OL by the reflective electrode 40 is required to balance the saturation and the luminance by setting the peaks of the spectra of the light OL transmitted through the color filters 20 and adjusting an area ratio of the color filters 20 having different peaks. In other words, the reflective display device has an extreme difficulty in adjusting colors and luminance by adjusting the light source, which can be achieved by a display device including a light source. Application of the present embodiment to even such a reflective display device having the foregoing limitations can still reliably obtain the luminance and saturation of the yellow Y. The reflective display device in the embodiment may be able to use an artificial light source, such as a front light. In this case, the reflective display device in the embodiment can still reliably obtain the luminance and saturation of the yellow Y without the need to adjust, for example, tints of colors obtained from the artificial light source.

In the embodiment, the area ratio of the first color filter 20RG1, the second color filter 20BG1, the third color filter 20R1, and the fourth color filter 20B1, and the spectra of the red green RG1, the blue green BG1, the red R1, and the blue B1 are determined depending on the required white point W and the required luminance and the saturation of the yellow Y. The blue B1 in the embodiment and the conventional blue (B), which are identical to each other in FIG. 5, may be different from each other. The red R1 in the embodiment and the conventional red (R), which are identical to each other in FIG. 5, may be different from each other. Although the combination of the red green RG1 and the blue green BG1 reproduces the conventional green (G) in FIG. 5, the combination of the red green RG1 and the blue green BG1 may reproduce green that is different from the conventional green (G).

FIG. 6 is a chart indicating exemplary color reproducibility of the embodiment and that of a comparative example in an L*a*b* color space. In FIG. 6, SNAP indicates yellow, green, cyan, blue, magenta, and red specified by the Specifications for Newsprint Advertising Production. A display device in the comparative example is an RGBW reflective display device that includes sub-pixels of four colors, i.e., white (W) in addition to the conventional red (R), the conventional green (G), and the conventional blue (B). The display device in the embodiment described with reference to FIGS. 1 to 5 can reproduce the yellow Y that is brighter and more vivid than yellow OY to be reproduced by the display device in the comparative example. The display device in the embodiment can satisfy, in particular, the demand in advertisement or the like for display of bright and vivid yellow by reproducing the yellow Y.

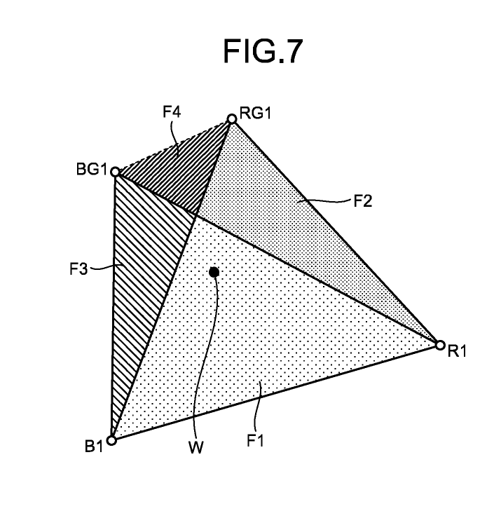

FIG. 7 is a chromaticity diagram schematically illustrating a relation between ranges of colors that can be reproduced with the first sub-pixel 11, the third sub-pixel 13, and the fourth sub-pixel 14 and ranges of colors that can be reproduced with the second sub-pixel 12, the third sub-pixel 13, and the fourth sub-pixel 14. The ranges of colors to be reproduced with the first sub-pixel 11, the third sub-pixel 13, and the fourth sub-pixel 14 are ranges of colors (range F1+range F2) established on the basis of the spectra of the red green RG1, the red R1, and the blue B1. The ranges of colors to be reproduced with the second sub-pixel 12, the third sub-pixel 13, and the fourth sub-pixel 14 are ranges of colors (range F1+range F3) established on the basis of the spectra of the blue green BG1, the red R1, and the blue B1. The range F1 represents an overlapping range in which the ranges of colors to be reproduced with the first sub-pixel 11, the third sub-pixel 13, and the fourth sub-pixel 14 overlap the ranges of colors to be reproduced with the second sub-pixel 12, the third sub-pixel 13, and the fourth sub-pixel 14. The range F2 represents a range in which the ranges of colors to be reproduced with the first sub-pixel 11, the third sub-pixel 13, and the fourth sub-pixel 14 do not overlap the ranges of colors to be reproduced with the second sub-pixel 12, the third sub-pixel 13, and the fourth sub-pixel 14. The range F3 represents a range in which the ranges of colors to be reproduced with the second sub-pixel 12, the third sub-pixel 13, and the fourth sub-pixel 14 do not overlap the ranges of colors to be reproduced with the first sub-pixel 11, the third sub-pixel 13, and the fourth sub-pixel 14.

Combining either one of the first sub-pixel 11 and the second sub-pixel 12 with the third sub-pixel 13 and the fourth sub-pixel 14 allows colors included in the range F1 to be reproduced. The range F1 includes the white point (W). Thus, a single pixel including either one of the first sub-pixel 11 and the second sub-pixel 12, the third sub-pixel 13, and the fourth sub-pixel 14 can reproduce white.

Meanwhile, colors included in the range F2 cannot be reproduced when the first sub-pixel 11 is not used. Colors included in the range F3 cannot be reproduced when the second sub-pixel 12 is not used. To reproduce a color included in a range F4 that overlaps none of the ranges F1, F2, and F3 out of ranges of colors established on the basis of the spectra of the red green RG1, the blue green BG1, the red R1, and the blue B1, both the first sub-pixel 11 and the second sub-pixel 12 are required. Thus, in a configuration in which each pixel includes either one of the first sub-pixel 11 and the second sub-pixel 12, the third sub-pixel 13, and the fourth sub-pixel 14, the first sub-pixel 11 is disposed in one of two adjacent pixels and the second sub-pixel 12 is disposed in the other of the two adjacent pixels. The foregoing arrangement enables the ranges of colors established on the basis of the spectra of the red green RG1, the blue green BG1, the red R1, and the blue B1 to be covered by a combination of the sub-pixels 15 included in the two adjacent pixels.

The term “sub-pixel rendering”, as used in the following description, refers to a process of allocating a color component of a sub-pixel 15 not included in a single pixel to a sub-pixel 15 included in a pixel adjacent to the single pixel.

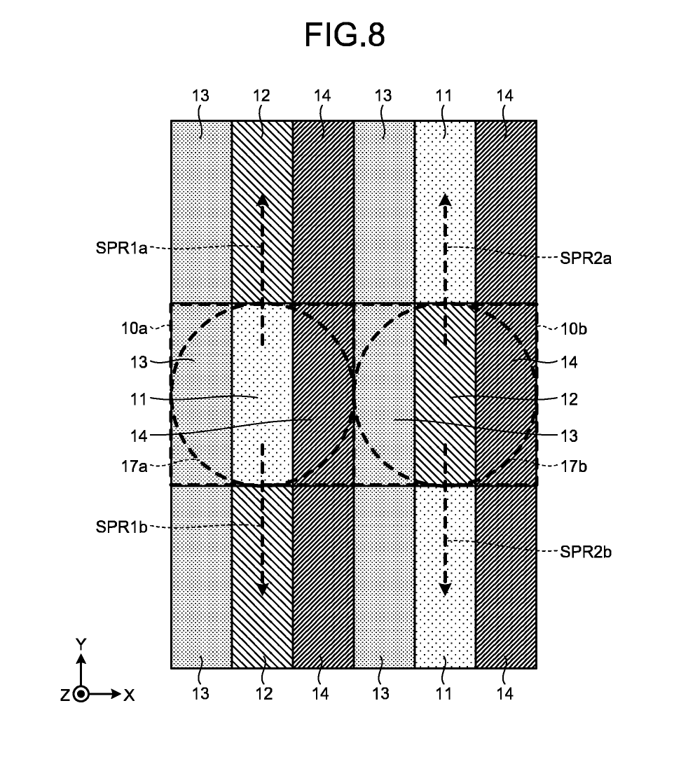

FIG. 8 is a diagram schematically illustrating exemplary sub-pixel rendering to be performed in color reproduction by a pixel 10a including the first sub-pixel 11, the third sub-pixel 13, and the fourth sub-pixel 14, and a pixel 10b including the second sub-pixel 12, the third sub-pixel 13, and the fourth sub-pixel 14. The pixel 10a does not include the second sub-pixel. Thus, when color reproduction using the blue green BG1 is required, the color component corresponding to the blue green BG1 is allocated to the second sub-pixel 12 adjacent to the pixel 10a. Specifically, the sub-pixel rendering is performed for reproduction of a color, such as yellow, which needs to be reproduced using the first sub-pixel 11, the second sub-pixel 12, and the third sub-pixel 13. As described above with reference to FIGS. 5 and 6, to obtain the luminance and saturation of the yellow, it is preferable to use a sub-pixel 15 encompassing a wider region and including a color filter exhibiting high light transmission efficiency. For this reason, the color component is allocated to a sub-pixel 15 included in another pixel (e.g., the second sub-pixel 12 adjacent to the pixel 10a) by the sub-pixel rendering. The foregoing approach allows the region used for color reproduction to be greater and the yellow to be reproduced using the sub-pixel 15 that includes a color filter exhibiting higher light transmission efficiency. That is, the sub-pixel rendering can achieve sufficient reproducibility of a color, such as the yellow, which has stringent requirements for luminance and saturation.

There are a plurality of conditions that determine a relation between a ratio of a component allocated to the red green RG1 and a ratio of a component allocated to the blue green BG1 out of a green component (G) included in a color that is indicated by an input gradation value for one pixel. One of the conditions is a ratio of a red component (R) and a ratio of a blue component (B), which are components other than the green component (G), out of the input gradation value of the pixel. Another one of the conditions is an intensity of the red component reproduced by the red green RG1 and an intensity of the blue component reproduced by the blue green BG1. Still another one of the conditions is an area ratio in an X-Y plane of each of the first sub-pixel 11, the second sub-pixel 12, the third sub-pixel 13, and the fourth sub-pixel 14. For simpler explanation, the following illustrates a case in which a green component corresponding to the gradation value input as the green component (G) is equally allocated to the red green RG1 and the blue green BG1.

In FIG. 8, an arrow SPR1a indicates allocation of the color component to one (upper one in FIG. 8) of the two second sub-pixels 12 adjacent to the pixel 10a in the Y-direction. An arrow SPR1b indicates allocation of the color component to the other (lower one in FIG. 8) of the two second sub-pixels 12 adjacent to the pixel 10a in the Y-direction. When both of the two second sub-pixels 12 adjacent to the pixel 10a in the Y-direction are used, one-quarter of the green component (G) included in the color indicated by the input gradation value of the pixel 10a is allocated to each of the two second sub-pixels 12. When either one of the two second sub-pixels 12 is used, one-half of the green component (G) included in the color indicated by the input gradation value of the pixel 10a is allocated to that specific second sub-pixel 12. In either case, the remaining one-half is allocated to the first sub-pixel 11 of the pixel 10a.

In FIG. 8, an arrow SPR2a indicates allocation of the color component to one (upper one in FIG. 8) of the two first sub-pixels 11 adjacent to the pixel 10b in the Y-direction. An arrow SPR2b indicates allocation of the color component to the other (lower one in FIG. 8) of the two first sub-pixels 11 adjacent to the pixel 10b in the Y-direction. When both of the two first sub-pixels 11 adjacent to the pixel 10b in the Y-direction are used, one-quarter of the green component (G) included in the color indicated by the input gradation value of the pixel 10b is allocated to each of the two first sub-pixels 11. When either one of the two first sub-pixels 11 is used, one-half of the green component (G) included in the color indicated by the input gradation value of the pixel 10b is allocated to that specific first sub-pixel 11. In either case, the remaining one-half is allocated to the second sub-pixel 12 of the pixel 10b. Each of the sub-pixels 15 is driven according to the color component allocated thereto.

When, in the sub-pixel rendering, both of the two sub-pixels 15 adjacent to each other in the Y-direction are used, the color component is equally allocated to the pixels arrayed in the Y-direction (vertically) centering on a sub-pixel row including a single pixel that serves as a color allocation source. Specifically, the color component is not allocated unevenly to a position of another pixel based on the single pixel that serves as the color allocation source. Thus, even when the sub-pixel rendering is performed and color expression of a specific pixel is given using not only the specific pixel but also the pixels around the specific pixel, a color gravitational center does not deviate from the specific pixel. FIG. 8 schematically illustrates a color gravitational center 17a of the pixel 10a and a color gravitational center 17b of the pixel 10b in this case. Meanwhile, it is necessary to retain input gradation values of three sub-pixel rows, i.e., the sub-pixel row of the specific pixel that serves as the color allocation source, and the sub-pixel rows adjacent to the sub-pixel row in the Y-direction.

When only one of the two sub-pixels 15 adjacent to each other in the Y-direction is used in the sub-pixel rendering, the color gravitational center deviates to the one of the two sub-pixels 15 from the specific pixel. Meanwhile, retention of the input gradation values is required only for two rows including the sub-pixel row of the specific pixel that serves as the color allocation source and the sub-pixel row adjacent to the foregoing sub-pixel row.

Deviation in the color gravitational center (e.g., color gravitational center 17a or color gravitational center 17b) in the sub-pixel rendering attributes to an input gradation value, by which a color component not included in a specific pixel (e.g., pixel 10a or pixel 10b) is allocated to the specific pixel. In other words, deviation in the color gravitational center does not occur when the specific pixel can reproduce a color corresponding to the input gradation value.

FIG. 3 illustrates a case in which the first sub-pixel 11, the second sub-pixel 12, the third sub-pixel 13, and the fourth sub-pixel 14 each have the same shape and the same area. The shapes and sizes of the sub-pixels 15 in the arrangement of the sub-pixels 15 illustrated in FIG. 3 are illustrative only and do not limit the present disclosure. The sub-pixels 15 including the color filters 20 of different colors may have shapes and areas different in part or in its entirety from one another. In this case, the areas are determined, for example, on the basis of color reproduction intended for the reflective display device. For example, each of the third sub-pixel 13 and the fourth sub-pixel 14 may be made greater in size than the first sub-pixel 11 and the second sub-pixel 12. In this case, the third sub-pixel 13 and the fourth sub-pixel 14 each have a color filter 20 and a reflective electrode 40 (see FIG. 1) having areas greater than those of the first sub-pixel 11 and the second sub-pixel 12. An area ratio of the sub-pixels 15 having different colors is, for example, an area ratio of the reflective electrodes 40 included in the respective sub-pixels 15. An area ratio of the color filters 20 included in respective sub-pixels 15 may not necessarily be identical to an area ratio of the reflective electrodes 40, because of the influence of a black matrix 23 to be described later; however, a magnitude relation of the color filters 20 is identical to a magnitude relation indicated by the area ratio of the reflective electrodes 40.

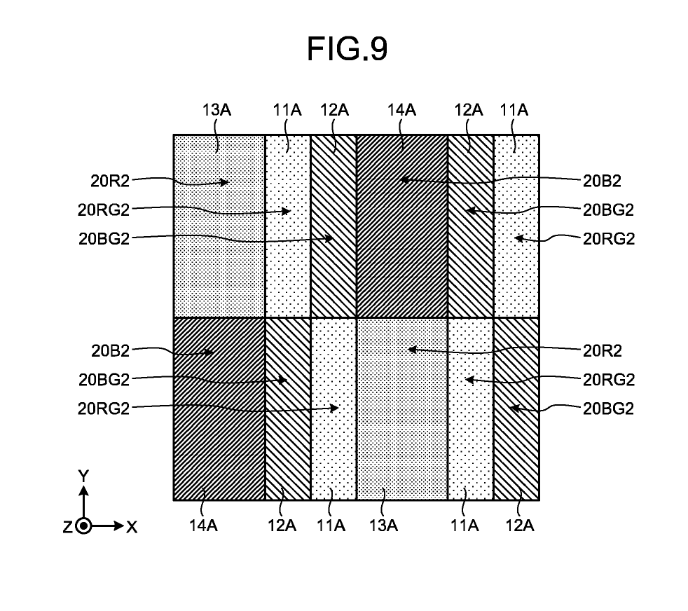

FIG. 9 is a diagram illustrating exemplary shapes of sub-pixels 15 that are different from the sub-pixels 15 illustrated in FIG. 3, an exemplary positional relation among the sub-pixels 15, and exemplary color filters 20 of the respective sub-pixels 15. In the example illustrated in FIG. 9, a first one of first sub-pixels 11A is adjacent to a first one of third sub-pixels 13A in the X-direction. A first one of second sub-pixels 12A is adjacent to a first one of fourth sub-pixels 14A in the X-direction. The first one of the first sub-pixels 11A is adjacent to the first one of the second sub-pixels 12A in the Y-direction. None of the first sub-pixels 11A is adjacent to any of the third sub-pixels 13A in the Y-direction. None of the first sub-pixels 11A is adjacent to any of the fourth sub-pixels 14A in the Y-direction. None of the second sub-pixels 12A is adjacent to any of the third sub-pixels 13A in the Y-direction. None of the second sub-pixels 12A is adjacent to any of the fourth sub-pixels 14A in the Y-direction. The foregoing positional relations among the first sub-pixels 11A, the second sub-pixels 12A, the third sub-pixels 13A, and the fourth sub-pixels 14A are identical to the positional relations among the first sub-pixels 11, the second sub-pixels 12, the third sub-pixels 13, and the fourth sub-pixels 14 illustrated in FIG. 3. In the example illustrated in FIG. 9, a region combining three out of the first sub-pixels 11A, the second sub-pixels 12A, the third sub-pixels 13A, and the fourth sub-pixels 14A has a square shape. Specifically, a region combining three sub-pixels 15 that are consecutive in the X-direction has a square shape. A plurality of sub-pixels 15 included in such a square region may serve as one pixel.

In the example illustrated in FIG. 9, unlike the example illustrated in FIG. 3, the first one of the first sub-pixels 11A is adjacent to another one of the second sub-pixels 12A in the X-direction. The first one of the third sub-pixels 13A is adjacent to the first one of the fourth sub-pixels 14A in the Y-direction. None of the first sub-pixels 11A is adjacent to any one of the fourth sub-pixels 14A in the X-direction. None of the second sub-pixels 12A is adjacent to any of the third sub-pixels 13A in the X-direction. None of the third sub-pixels 13A is adjacent to any of the fourth sub-pixels 14A in the X-direction.

In the example illustrated in FIG. 9, an array of the third sub-pixel 13A, the first sub-pixel 11A, the second sub-pixel 12A, the fourth sub-pixel 14A, the second sub-pixel 12A, and the first sub-pixel 11A placed in juxtaposition is repeated in the pixel row. An array of pixel columns in the X-direction is as follows: a pixel column in which the third sub-pixel 13A and the fourth sub-pixel 14A are alternately arranged in the Y-direction; a pixel column in which the first sub-pixel 11A and the second sub-pixel 12A are alternately arranged in the Y-direction; a pixel column in which the second sub-pixel 12A and the first sub-pixel 11A are alternately arranged in the Y-direction; and a pixel column in which the fourth sub-pixel 14A and the third sub-pixel 13A are alternately arranged in the Y-direction.

In the example illustrated in FIG. 9, the third sub-pixel 13A and the fourth sub-pixel 14A are each greater in size than the first sub-pixel 11A and the second sub-pixel 12A. Specifically, in the example illustrated in FIG. 9, the first sub-pixel 11A and the second sub-pixel 12A each have a width in the X-direction smaller than a width in the X-direction of the third sub-pixel 13A and a width in the X-direction of the fourth sub-pixel 14A. In the entire reflective display device, the number of the first sub-pixels 11A and the number of the second sub-pixels 12A are each greater than the number of the third sub-pixels 13A and the number of the fourth sub-pixels 14A (e.g., twofold). In this manner, colors in the entire reflective display device may be balanced through a combination of the numbers and areas of sub-pixels 15 including the color filters 20 of different colors. A first color filter 20RG2, a second color filter 20BG2, a third color filter 20R2, and a fourth color filter 20B2 illustrated in FIG. 9 may have characteristics identical to, or different from, characteristics of the first color filter 20RG1, the second color filter 20BG1, the third color filter 20R1, and the fourth color filter 20B1 illustrated in FIG. 3. When the area ratio of the sub-pixels 15 having different colors is identical between the example in FIG. 3 and the example in FIG. 9, the color filters 20 may have the same characteristics in order to make the ranges of reproducible colors identical in both the cases. When the area ratio of the sub-pixels 15 having different colors differs between the example in FIG. 3 and the example in FIG. 9, for example, the color filters 20 having different characteristics are employed in order to make the ranges of reproducible colors different between these cases.

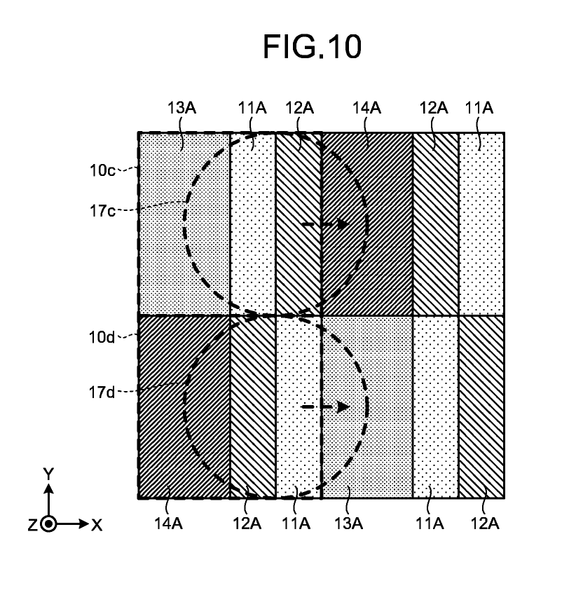

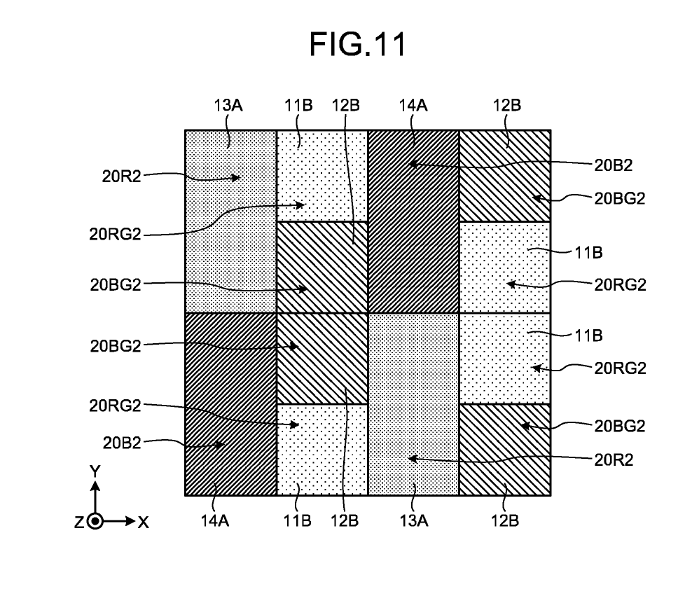

FIG. 10 is a diagram schematically illustrating exemplary sub-pixel rendering to be performed in color reproduction by a pixel 10c including the first sub-pixel 11A, the second sub-pixel 12A, and the third sub-pixel 13A and a pixel 10d including the first sub-pixel 11A, the second sub-pixel 12A, and the fourth sub-pixel 14A. In the example illustrated in FIG. 10, the sub-pixel rendering allocates a color to the fourth sub-pixel 14A adjacent to the pixel 10c in the X-direction, and allocates a color to the third sub-pixel 13A adjacent to the pixel 10d in the X-direction. Thus, in the example illustrated in FIG. 10, when an input gradation value requiring allocation of a color is input, a color gravitational center 17c of the pixel 10c and a color gravitational center 17d of the pixel 10d are deviated in the X-direction. The color gravitational centers 17c and 17d are not, however, deviated in the Y-direction. Thus, an effect of the deviation in the color gravitational centers on an image impression is extremely small. Retention of the input gradation values is required only for one sub-pixel row including a specific pixel that serves as the color allocation source.

FIG. 11 is a diagram illustrating exemplary shapes of sub-pixels 15 that are different from the sub-pixels 15 illustrated in FIGS. 3 and 9, an exemplary positional relation among the sub-pixels 15, and exemplary color filters 20 of the respective sub-pixels 15. In the example illustrated in FIG. 11, a first one of first sub-pixels 11B is adjacent to a first one of the third sub-pixels 13A in the X-direction. A first one of second sub-pixels 12B is adjacent to a first one of the fourth sub-pixels 14A in the X-direction. The first one of the first sub-pixels 11B is adjacent to the first one of the second sub-pixels 12B in the Y-direction. None of the first sub-pixels 11B is adjacent to any of the third sub-pixels 13A in the Y-direction. None of the first sub-pixels 11B is adjacent to any of the fourth sub-pixels 14A in the Y-direction. None of the second sub-pixels 12B is adjacent to any of the third sub-pixels 13A in the Y-direction. None of the second sub-pixels 12B is adjacent to any of the fourth sub-pixels 14A in the Y-direction. The foregoing positional relations among the first sub-pixels 11B, the second sub-pixels 12B, the third sub-pixels 13A, and the fourth sub-pixels 14A are identical to the positional relations among the first sub-pixels 11, the second sub-pixels 12, the third sub-pixels 13, and the fourth sub-pixels 14 illustrated in FIG. 3.

In the example illustrated in FIG. 11, the first one of the first sub-pixels 11B is adjacent to the first one of the fourth sub-pixels 14A in the X-direction. The first one of the second sub-pixels 12B is adjacent to the first one of the third sub-pixels 13A in the X-direction. None of the first sub-pixels 11B is adjacent to any of the second sub-pixels 12B in the X-direction.

In the example illustrated in FIG. 11, unlike the example illustrated in FIG. 3, none of the third sub-pixels 13A is adjacent to any of the fourth sub-pixels 14A in the X-direction. In the example illustrated in FIG. 11, a region combining three out of the first sub-pixel 11B, the second sub-pixel 12B, the third sub-pixel 13A, and the fourth sub-pixel 14A has a square shape. Specifically, a region of the following combination has a square shape: the first sub-pixel 11B; the second sub-pixel 12B adjacent to the first sub-pixel 11B in the Y-direction; and either one of the third sub-pixel 13A and the fourth sub-pixel 14A that are adjacent to the first sub-pixel 11B and the second sub-pixel 12B in the X-direction. A plurality of sub-pixels 15 included in the foregoing square region may serve as one pixel.

The third sub-pixel 13A and the fourth sub-pixel 14A are each greater in size than the first sub-pixel 11B and the second sub-pixel 12B. Specifically, in the example illustrated in FIG. 11, the first sub-pixel 11B and the second sub-pixel 12B each have a width in the Y-direction smaller than a width of the third sub-pixel 13A and a width of the fourth sub-pixel 14A. In the entire reflective display device, the number of the first sub-pixels 11B and the number of the second sub-pixels 12B are each greater than the number of the third sub-pixels 13A and the number of the fourth sub-pixels 14A (e.g., twofold). A width combining one first sub-pixel 11B and one second sub-pixel 12B adjacent to each other in the Y-direction is identical to a width in the Y-direction of one third sub-pixel 13A and a width in the Y-direction of one fourth sub-pixel 14A.

The example illustrated in FIG. 11 represents a configuration in which the first sub-pixel 11B and the second sub-pixel 12B respectively having shapes different from the shape of the first sub-pixel 11A illustrated in FIG. 9 and the shape of the second sub-pixel 12A illustrated in FIG. 9 are disposed in a region in which the first sub-pixel 11A and the second sub-pixel 12A are disposed in FIG. 9. The first sub-pixel 11A has an area substantially identical to an area of the first sub-pixel 11B. The second sub-pixel 12A has an area substantially identical to an area of the second sub-pixel 12B. Thus, the same first color filter 20RG2, second color filter 20BG2, third color filter 20R2, and fourth color filter 20B2 can be employed in the examples illustrated in FIGS. 9 and 11. Further, a color allocation destination and the color gravitational center in the sub-pixel rendering in the example illustrated in FIG. 11 are identical to those in the example illustrated in FIG. 9.

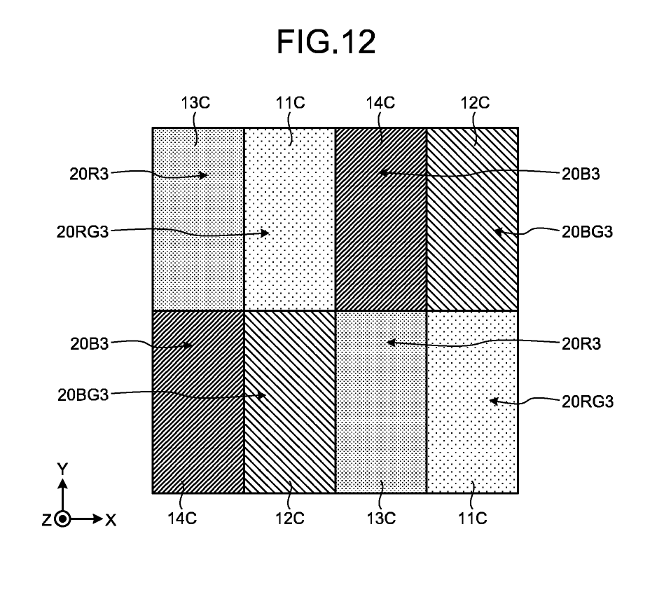

FIG. 12 is a diagram illustrating exemplary shapes of sub-pixels 15 that are different from the sub-pixels 15 illustrated in FIGS. 3, 9, and 11, an exemplary positional relation among the sub-pixels 15, and exemplary color filters 20 of the respective sub-pixels 15. In the example illustrated in FIG. 12, a first one of first sub-pixels 11C is adjacent to a first one of third sub-pixels 13C in the X-direction. A first one of second sub-pixels 12C is adjacent to a first one of fourth sub-pixels 14C in the X-direction. The first one of the first sub-pixels 11C is adjacent to the first one of second sub-pixels 12C in the Y-direction. None of the first sub-pixels 11C is adjacent to any of the third sub-pixels 13C in the Y-direction. None of the first sub-pixels 11C is adjacent to any of the fourth sub-pixels 14C in the Y-direction. None of the second sub-pixels 12C is adjacent to any of the third sub-pixels 13C in the Y-direction. None of the second sub-pixels 12C is adjacent to any of the fourth sub-pixels 14C in the Y-direction. The foregoing positional relations among the first sub-pixels 11C, the second sub-pixels 12C, the third sub-pixels 13C, and the fourth sub-pixels 14C are identical to the positional relations among the first sub-pixels 11, the second sub-pixels 12, the third sub-pixels 13, and the fourth sub-pixels 14 illustrated in FIG. 3.

In the example illustrated in FIG. 12, the first one of the first sub-pixels 11C is adjacent to a second one of the fourth sub-pixels 14C in the X-direction. The first one of the second sub-pixels 12C is adjacent to a second one of the third sub-pixels 13C in the X-direction. None of the first sub-pixels 11C is adjacent to any of the second sub-pixels 12C in the X-direction. The foregoing positional relations among the first sub-pixels 11C, the second sub-pixels 12C, the third sub-pixels 13C, and the fourth sub-pixels 14C are identical to the positional relations among the first sub-pixels 11, the second sub-pixels 12, the third sub-pixels 13, and the fourth sub-pixels 14 illustrated in FIG. 3.

In the example illustrated in FIG. 12, unlike the example illustrated in FIG. 3, none of the third sub-pixels 13C is adjacent to any of the fourth sub-pixels 14C in the X-direction. In the example illustrated in FIG. 12, a region combining two sub-pixels adjacent to each other in the X-direction out of the first sub-pixel 11C, the second sub-pixel 12C, the third sub-pixel 13C, and the fourth sub-pixel 14C has a square shape. A plurality of sub-pixels 15 included in the foregoing square region may serve as one pixel.

In the example illustrated in FIG. 12, an array of the third sub-pixel 13C, the first sub-pixel 11C, the fourth sub-pixel 14C, and the second sub-pixel 12C placed in juxtaposition is repeated in the pixel row. An array of pixel columns in the X-direction is as follows: a pixel column in which the third sub-pixel 13C and the fourth sub-pixel 14C are alternately arranged in the Y-direction; a pixel column in which the first sub-pixel 11C and the second sub-pixel 12C are alternately arranged in the Y-direction; a pixel column in which the fourth sub-pixel 14C and the third sub-pixel 13C are alternately arranged in the Y-direction; and a pixel column in which the second sub-pixel 12C and the first sub-pixel 11C are alternately arranged in the Y-direction.

FIG. 12 illustrates a case in which the first sub-pixel 11C, the second sub-pixel 12C, the third sub-pixel 13C, and the fourth sub-pixel 14C each have a shape and an area identical to one another. The shapes and sizes of the sub-pixels 15 in the arrangement of the sub-pixels 15 illustrated in FIG. 12 are illustrative only and do not limit the present disclosure.

A first color filter 20RG3, a second color filter 20BG3, a third color filter 20R3, and a fourth color filter 20B3 illustrated in FIG. 12 may be identical to, or different from, the first color filter 20RG2, the second color filter 20BG2, the third color filter 20R2, and the fourth color filter 20B2 illustrated in FIG. 9.

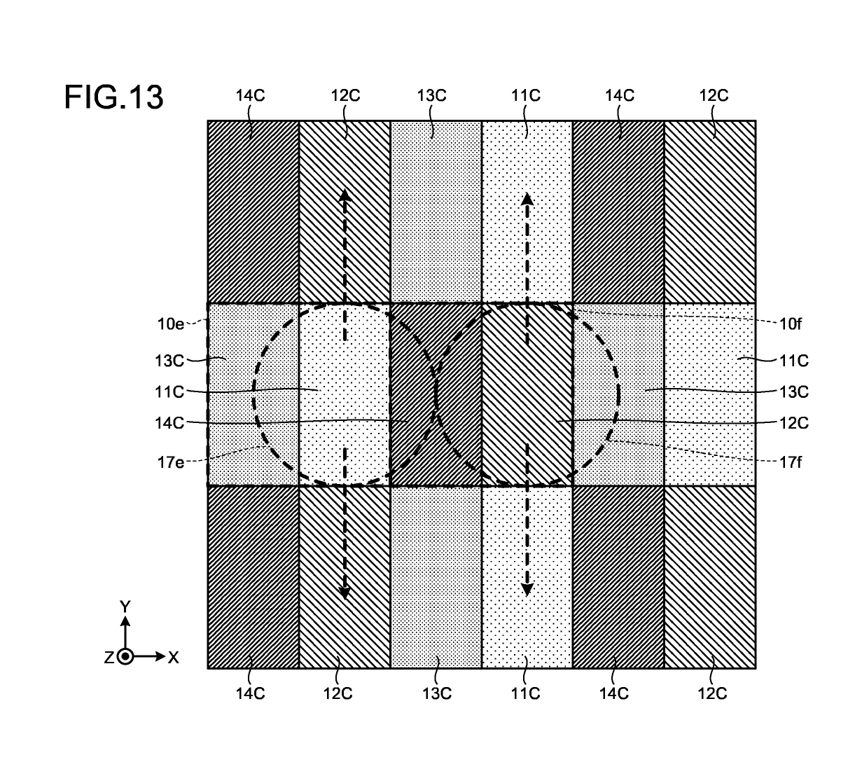

FIG. 13 is a diagram schematically illustrating exemplary sub-pixel rendering to be performed in color reproduction by a pixel 10e including the first sub-pixel 11C and the third sub-pixel 13C and a pixel 10f including the second sub-pixel 12C and the fourth sub-pixel 14C. In the example illustrated in FIG. 13, the sub-pixel rendering allocates a color to the fourth sub-pixel 14C adjacent to the pixel 10e in the X-direction, and allocates a color to the third sub-pixel 13C adjacent to the pixel 10f in the X-direction. Similarly to the example illustrated in FIG. 10, in the example illustrated in FIG. 13, when an input gradation value requiring allocation of a color is input, a color gravitational center 17e of the pixel 10e and a color gravitational center 17f of the pixel 10f are deviated in the X-direction.

In the example illustrated in FIG. 13, at least one of the two second sub-pixels 12C adjacent to the pixel 10e in the Y-direction is used in the sub-pixel rendering. In the example illustrated in FIG. 13, at least one of the two first sub-pixels 11C adjacent to the pixel 10f in the Y-direction is used in the sub-pixel rendering. Thus, the matters regarding the deviation in the color gravitational centers 17e and 17f in the Y-direction, and the number of pixel rows whose input gradation values are retained, which are described with reference to FIG. 3, also apply to the example illustrated in FIG. 13.

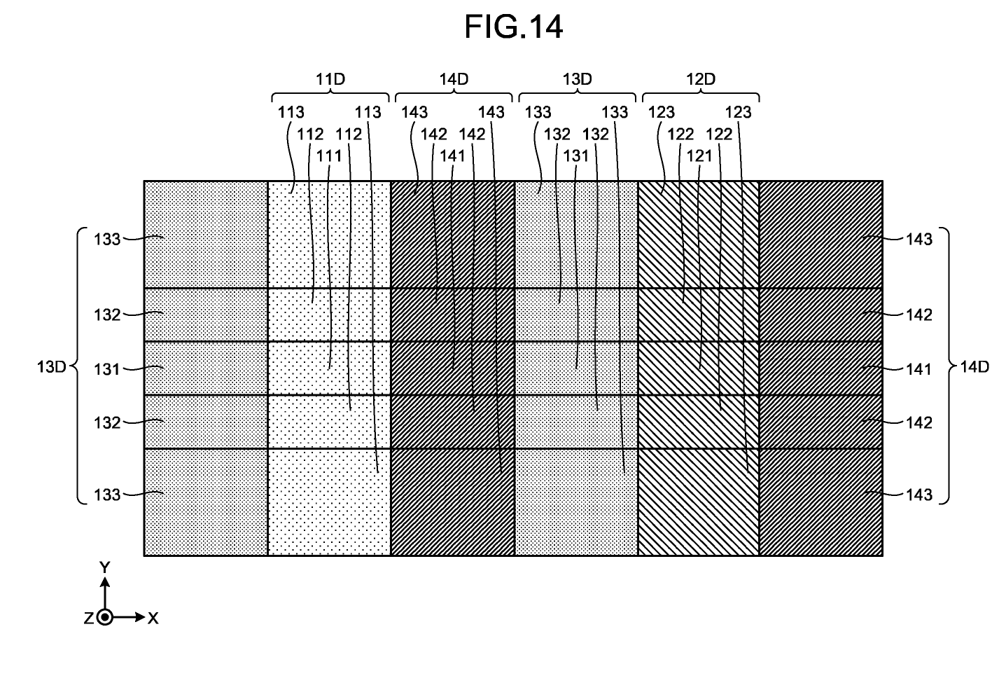

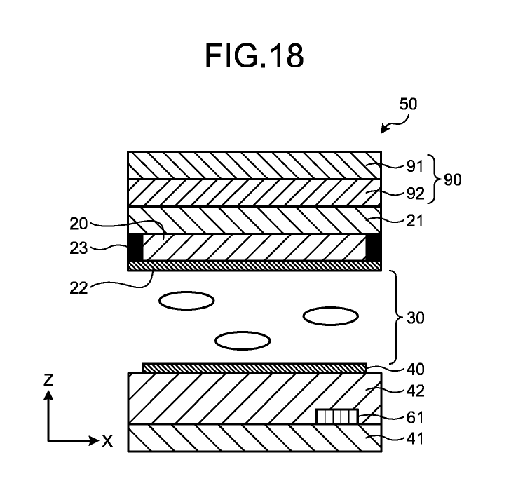

FIG. 14 is a diagram illustrating an example of dividing each sub-pixel 15 into a plurality of regions having different areas for area coverage modulation. A first sub-pixel 11D including the first color filter 20RG1 includes three regions having different areas including a first sub-divided pixel 111, a second sub-divided pixel 112, and a third sub-divided pixel 113. An area ratio of the first sub-divided pixel 111, the second sub-divided pixel 112, and the third sub-divided pixel 113 is 1 to 2 to 4 (=2⁰ to 2¹ to 2²), for example. The first sub-pixel 11D has gradation performance of three bits (eight gradations) through combinations of whether each of the first sub-divided pixel 111, the second sub-divided pixel 112, and the third sub-divided pixel 113 transmits light. More specifically, area coverage modulation performed through the combination patters of whether each of the first sub-divided pixel 111, the second sub-divided pixel 112, and the third sub-divided pixel 113 transmits light is expressed as “0:0:0”, “1:0:0”, “0:1:0”, “1:1:0”, “0:0:1”, “1:0:1”, “0:1:1”, and “1:1:1” in ascending order of an output gradation, where 1 denotes that the specific sub-divided pixel transmits light and 0 denotes that the specific sub-divided pixel does not transmit light. Among the sub-pixels 15, the black matrix 23 (see FIG. 18) is disposed, for example, among a plurality of color filters 20. For example, the black matrix 23 may be a black filter or may be configured such that the color filters of two adjacent to sub-pixels are superimposed on top of one another to reduce a transmission factor in the overlapping part. The black matrix 23 may be omitted. A ratio of area coverage modulation by the sub-divided pixels (e.g., 1 to 2 to 4) corresponds to an aperture ratio in a plan view. Thus, in a configuration including the black matrix 23, the ratio of area coverage modulation corresponds to a ratio of openings on which the black matrix 23 is not disposed. In a configuration without the black matrix 23, the ratio of area coverage modulation corresponds to an area ratio of the reflective electrodes 40 included in the respective sub-divided pixels. Specific shapes of the reflective electrodes 40 vary depending on how the sub-pixel 15 is divided. For example, in FIG. 14, the third sub-divided pixel 113, the second sub-divided pixel 112, the first sub-divided pixel 111, the second sub-divided pixel 112, and the third sub-divided pixel 113 are disposed so as to divide the rectangular first sub-pixel 11D into five parts in a longitudinal direction (Y-direction). The specific form of dividing a single sub-pixel 15 may be changed as appropriate.

The second sub-pixel 12D provided with the second color filter 20BG1 includes a plurality of sub-divided pixels such as a first sub-divided pixel 121, a second sub-divided pixel 122, and a third sub-divided pixel 123. The third sub-pixel 13D provided with the third color filter 20R1 includes a plurality of sub-divided pixels such as a first sub-divided pixel 131, a second sub-divided pixel 132, and a third sub-divided pixel 133. The fourth sub-pixel 14D provided with the fourth color filter 20B1 includes a plurality of sub-divided pixels such as a first sub-divided pixel 141, a second sub-divided pixel 142, and a third sub-divided pixel 143. The second sub-pixel 12D, the third sub-pixel 13D, and the fourth sub-pixel 14D each achieve the area coverage modulation through the same mechanism as that of the first sub-pixel 11D.

The first sub-pixel 11D, the second sub-pixel 12D, the third sub-pixel 13D, and the fourth sub-pixel 14D are configured in the same manner as the first sub-pixel 11, the second sub-pixel 12, the third sub-pixel 13, and the fourth sub-pixel 14 described above, respectively, except that the first sub-pixel 11D, the second sub-pixel 12D, the third sub-pixel 13D, and the fourth sub-pixel 14D each include the sub-divided pixels.

The sub-pixels 15 illustrated in FIG. 14 are each divided into a plurality of sub-divided pixels having different areas. Gradation expression for each of the sub-pixels 15 is performed through a combination of whether each of the sub-divided pixels transmits light. The number of sub-divided pixels included in a single sub-pixel 15 may be two, or four or more. Gradation performance of a single sub-pixel 15 in the area coverage modulation is indicated by the number of bits (N bits) corresponding to the number (N) of the sub-divided pixels, where N is a natural number of 2 or greater. Assuming that the area of the smallest sub-divided pixel is 1, the q-th (q-th bit) sub-divided pixel from the smallest sub-divided pixel has an area of 2^{(q-1)}.

The sub-pixels 15 illustrated in FIGS. 9, 11, and 12 may be divided into a plurality of sub-divided pixels in a similar manner to the sub-pixels 15 illustrated in FIG. 14.

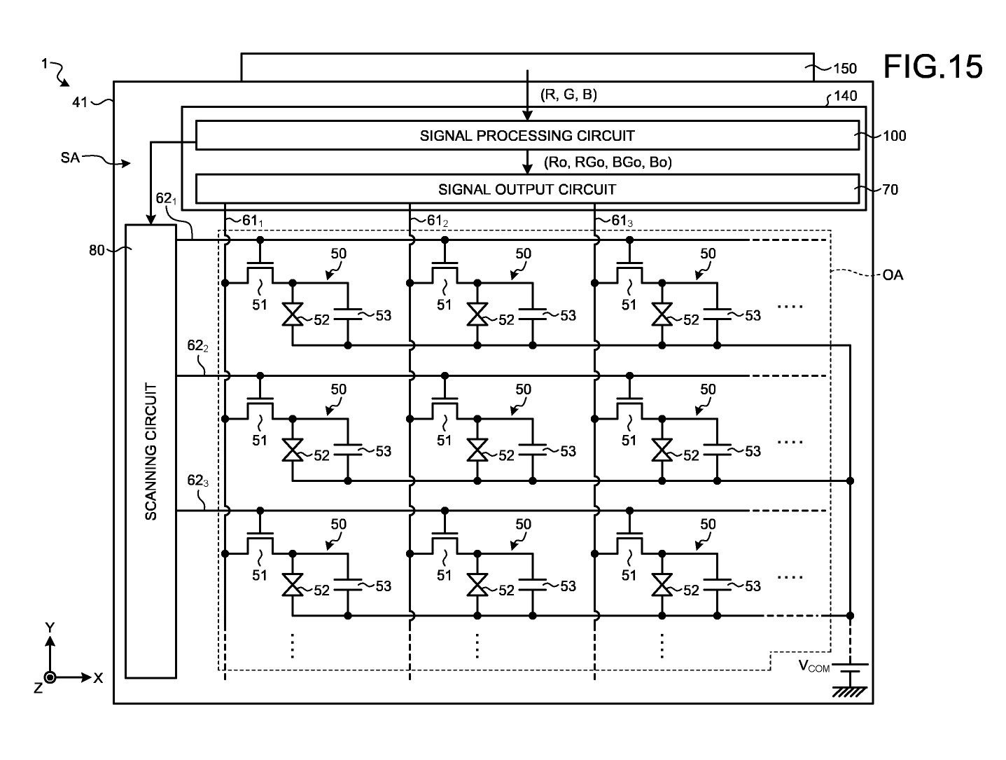

The following describes a detailed configuration of a display device 1 in the embodiment with reference to FIGS. 15 to 22. In the description with reference to FIGS. 15 to 22, one of the sub-divided pixels will be referred to as a “sub-divided pixel 50”.

FIG. 15 is a diagram illustrating an exemplary circuit configuration of the display device 1. The X-direction in FIG. 15 indicates a row direction of the display device 1, and the Y-direction in FIG. 15 indicates a column direction of the display device 1. As illustrated in FIG. 15, the sub-divided pixel 50 includes, for example, a pixel transistor 51 employing a thin-film transistor (TFT), a liquid crystal capacitor 52, and a holding capacitor 53. The pixel transistor 51 has a gate electrode coupled with a scanning line 62 (62₁, 62₂, 62₃, . . . ) and a source electrode coupled with a signal line 61 (61₁, 61₂, 61₃, . . . ).

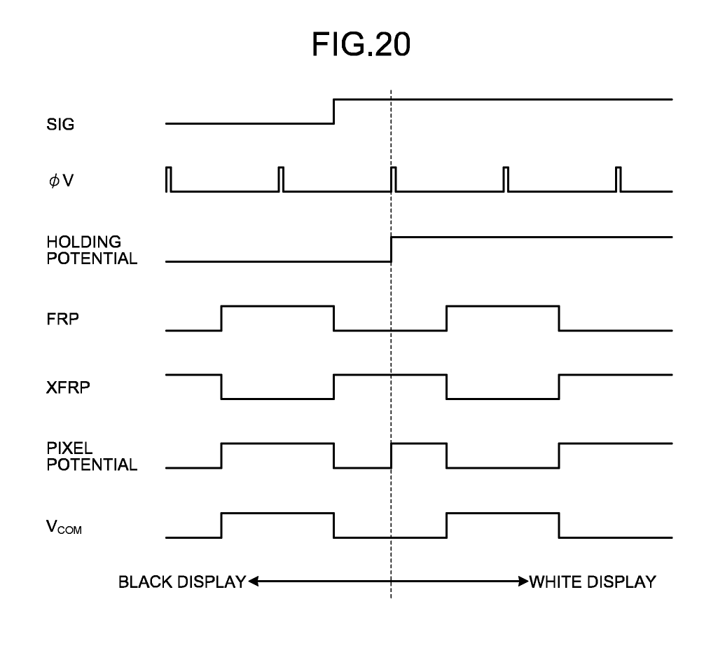

The liquid crystal capacitor 52 denotes a capacitance component of a liquid crystal material generated between the reflective electrode 40 provided for each sub-divided pixel 50 and a counter electrode 22 (see FIG. 18) facing more than one of or all of the reflective electrodes 40. The reflective electrode 40 is coupled with a drain electrode of the pixel transistor 51. A common potential V_{COM} is applied to the counter electrode 22. The common potential V_{COM} is inverted at predetermined cycles in order to inversely drive the sub-divided pixel 50 (see FIG. 20). The holding capacitor 53 has two electrodes, one of which has a potential identical to that of the reflective electrode 40, and the other of which has a potential identical to that of the counter electrode 22.

The pixel transistor 51 is coupled with the signal line 61 extending in the column direction and the scanning line 62 extending in the row direction. The sub-divided pixel 50 is at an intersection of the signal line 61 and the scanning line 62 in a display region OA. The signal lines 61 (61₁, 61₂, 61₃, . . . ) each have one end coupled with an output terminal corresponding to each column of a signal output circuit 70. The scanning lines 62 (62₁, 62₂, 62₃, . . . ) each have one end coupled with an output terminal corresponding to each row of a scanning circuit 80. The signal lines 61 (61₁, 61₂, 61₃, . . . ) each transmit a signal for driving the sub-divided pixels 50, i.e., a video signal output from the signal output circuit 70, to the sub-divided pixels 50, on a pixel column by pixel column basis. The scanning lines 62 (62ₖ, 62₂, 62₃, . . . ) each transmit a signal for selecting the sub-divided pixels 50 row by row, i.e., a scanning signal output from the scanning circuit 80, to each pixel row.

The signal output circuit 70 and the scanning circuit 80 are coupled with a signal processing circuit 100. The signal processing circuit 100 calculates a gradation value (R1, RG, BG, and B1 to be described later) of each of four sub-pixels 15 included in each pixel, in accordance with the input signal including the input gradation values of RGB. The signal processing circuit 100 outputs to the signal output circuit 70 a calculation result as area coverage modulation signals (Ro, RGo, BGo, and Bo) of each pixel. The signal output circuit 70 transmits to each sub-divided pixel 50 the video signal including the area coverage modulation signals (Ro, RGo, BGo, and Bo). The signal processing circuit 100 also outputs to the signal output circuit 70 and the scanning circuit 80 clock signals that synchronize operations of the signal output circuit 70 and the scanning circuit 80. The scanning circuit 80 scans the sub-divided pixels 50 in synchronism with the video signal from the signal output circuit 70. The embodiment may employ a configuration in which the signal output circuit 70 and the signal processing circuit 100 are included in, for example, a single IC chip 140 as illustrated in FIG. 8, or a configuration in which the signal output circuit 70 and the signal processing circuit 100 are individual circuit chips. FIG. 15 illustrates circuit chips including the IC chip 140, in a peripheral region SA of a first substrate 41 using a Chip-On-Glass (COG) technique. This is merely one example of implementation of the circuit chips, and the present disclosure is not limited thereto. The circuit chips may be mounted on, for example, a flexible printed circuit (FPC) coupled with the first substrate 41, using a Chip-On-Film (COF) technique.

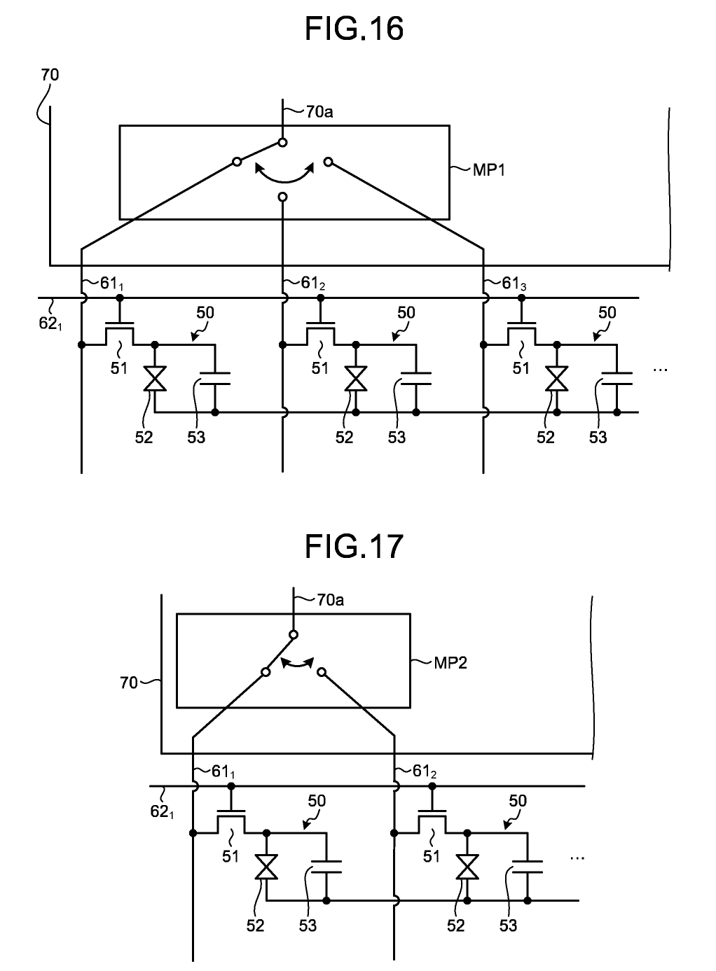

FIG. 16 is a diagram illustrating an exemplary multiplexer for a configuration of a single pixel including three sub-pixels 15. FIG. 17 is a diagram illustrating an exemplary multiplexer for a configuration of a single pixel including two sub-pixels 15. The exemplary configurations illustrated in FIGS. 16 and 17 each use an input terminal 70a to integrate video signals for the sub-pixels 15 included in the pixel, and sequentially output the signals to the sub-divided pixels 50 included in each of the sub-pixels 15 of the pixel in a switching manner by using a multiplexer MP1 or a multiplexer MP2 disposed in the signal output circuit 70. The multiplexer MP1 is used for a configuration, for example, in which a single pixel includes three sub-pixels 15 as illustrated in FIGS. 3, 9, and 11. The multiplexer MP2 is used for a configuration in which a single pixel includes two sub-pixels 15 as illustrated in FIG. 13. The foregoing specific configurations of the signal output circuit 70 are illustrative only and do not limit the present disclosure. The configurations may be changed as appropriate. The signal output circuit 70 may be configured to output the video signal individually to each sub-pixel 15 without using the multiplexer MP1 or the multiplexer MP2.

FIG. 18 is a cross-sectional view schematically illustrating the sub-divided pixel 50. The reflective electrode 40 faces the counter electrode 22 with the liquid crystal layer 30 interposed therebetween. The reflective electrode 40 is disposed on a display region OA of the first substrate 41. Specifically, wiring including the signal line 61, and an insulation layer 42 are stacked on a surface of the first substrate 41, the surface facing the liquid crystal layer 30. The insulation layer 42 insulates one wiring from another wiring and from electrodes. The reflective electrode 40 is formed for each sub-divided pixel 50. The reflective electrode 40 is a metal electrode, such as a silver (Ag) thin film, and reflects light. The counter electrode 22 and the color filter 20 are disposed on a display region OA of a second substrate 21. Specifically, the color filter 20 is disposed on a surface of the second substrate 21, the surface facing the liquid crystal layer 30. The black matrix 23 is disposed among the color filters 20. The counter electrode 22 is a film-shaped electrode formed on a surface of the color filter 20. The counter electrode 22 transmits light and is formed of, for example, indium tin oxide (ITO). The first substrate 41 and the second substrate 21 are formed of a light transmissive material such as glass and a transparent resin. The display region OA is capable of receiving the external light IL incident thereon and emitting the light OL. The peripheral region SA, on which a light blocking member identical to the black matrix 23 is disposed, is incapable of receiving the external light IL incident thereon and emitting the light OL. A configuration not including the black matrix may be employed to improve luminance.

An initial orientation state of liquid crystal molecules of the liquid crystal layer 30 is determined by orientation films (not illustrated) provided to the respective first and second substrates 41 and 21. The liquid crystal molecules do not transmit light in the initial orientation state. The state of not transmitting light in the initial orientation state in which no electric field is applied to the liquid crystal layer 30 is referred to as a normally black state.

The spectrum of the light OL transmitted through the color filter 20 illustrated in FIG. 18 has a peak that falls on either one of the spectrum of reddish green, the spectrum of bluish green, the spectrum of red, and the spectrum of blue, as described with reference to FIG. 3.

The reflective display device may include the light modulation layer 90 disposed on the opposite side of the liquid crystal layer 30 with the color filter 20 interposed therebetween, as described previously with reference to FIG. 1. The light modulation layer 90 includes, for example, a polarizing plate 91 and a scattering layer 92. The polarizing plate 91 faces a display surface. The scattering layer 92 is disposed between the polarizing plate 91 and the second substrate 21. The polarizing plate 91 prevents glare by transmitting beams of light polarized in a specific direction. The scattering layer 92 scatters the light OL reflected by the reflective electrode 40.

The display device 1 in the embodiment employs the sub-divided pixel 50 according to a memory-in-pixel (MIP) technology to have a memory function. According to the MIP technology, the sub-divided pixel 50 has a memory to store data, thereby allowing the display device 1 to perform display in a memory display mode. The memory display mode allows the gradation of the sub-divided pixel 50 to be digitally displayed based on binary information (logic “1” and logic “0”) stored in the memory in the sub-divided pixel 50.

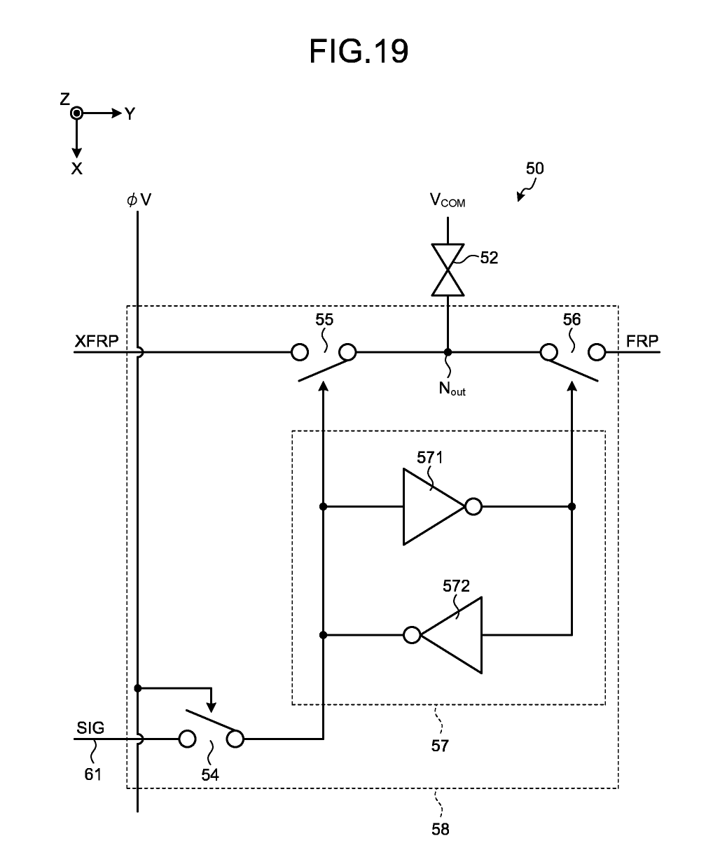

FIG. 19 is a block diagram illustrating an exemplary circuit configuration of the sub-divided pixel 50 employing the MIP technology. FIG. 20 is a timing chart for explaining an operation of the sub-divided pixel 50 employing the MIP technology. As illustrated in FIG. 19, the sub-divided pixel 50 includes a drive circuit 58 in addition to the liquid crystal capacitor (liquid crystal cell) 52. The drive circuit 58 includes three switching devices 54, 55, and 56 and a latch 57. The drive circuit 58 has a static random access memory (SRAM) function. The sub-divided pixel 50 including the drive circuit 58 is configured to have the SRAM function.

The switching device 54 has one end coupled with the signal line 61. The switching device 54 is turned ON (closed) by a scanning signal 4V applied from the scanning circuit 80, so that the drive circuit 58 obtains data SIG supplied from the signal output circuit 70 via the signal line 61. The latch 57 includes inverters 571 and 572. The inverters 571 and 572 are coupled in parallel with each other in directions opposite to each other. The latch 57 latches a potential corresponding to the data SIG obtained through the switching device 54.

A control pulse XFRP having a phase opposite to that of the common potential V_{COM} is applied to one terminal of the switching device 55. A control pulse FRP having a phase identical to that of the common potential V_{COM} is applied to one terminal of the switching device 56. The switching devices 55 and 56 each have the other terminal coupled with a common connection node. The common connection node serves as an output node Nₒᵤₜ. Either one of the switching devices 55 and 56 is turned ON depending on a polarity of the holding potential of the latch 57. Through the foregoing operation, the control pulse FRP or the control pulse XFRP is applied to the reflective electrode 40 while the common potential V_{COM} is being applied to the counter electrode 22 that generates the liquid crystal capacitor 52.

When the holding potential of the latch 57 has a negative polarity, the pixel potential of the liquid crystal capacitor 52 is in the same phase with that of the common potential V_{COM}, causing no potential difference between the reflective electrode 40 and the counter electrode 22. Thus, no electric field is generated in the liquid crystal layer 30. Consequently, the liquid crystal molecules are not twisted from the initial orientation state and the normally black state is maintained. As a result, light is not transmitted in this sub-divided pixel 50. On the other hand, when the holding potential of the latch 57 has a positive polarity, the pixel potential of the liquid crystal capacitor 52 is in an opposite phase of that of the common potential V_{COM}, causing a potential difference between the reflective electrode 40 and the counter electrode 22. An electric field then is generated in the liquid crystal layer 30. The electric field causes the liquid crystal molecules to be twisted from the initial orientation state and to change orientation thereof. Thus, light is transmitted in the sub-divided pixel 50 (light transmitted state). As described above, in the display device 1, the sub-divided pixels each include a holder (latch 57) that holds a potential variable according to gradation expression.

In each sub-divided pixel 50, the control pulse FRP or the control pulse XFRP is applied to the reflective electrode 40 generating the liquid crystal capacitor 52 when either one of the switching devices 55 and 56 is turned ON depending on the polarity of the holding potential of the latch 57. Transmission of light is thereby controlled for the sub-divided pixel 50.

The foregoing describes the example in which the sub-divided pixel 50 employs the SRAM as a memory incorporated in the sub-divided pixel 50. The SRAM is, however, illustrative only and the embodiment may employ other types of memory, for example, a dynamic random access memory (DRAM).

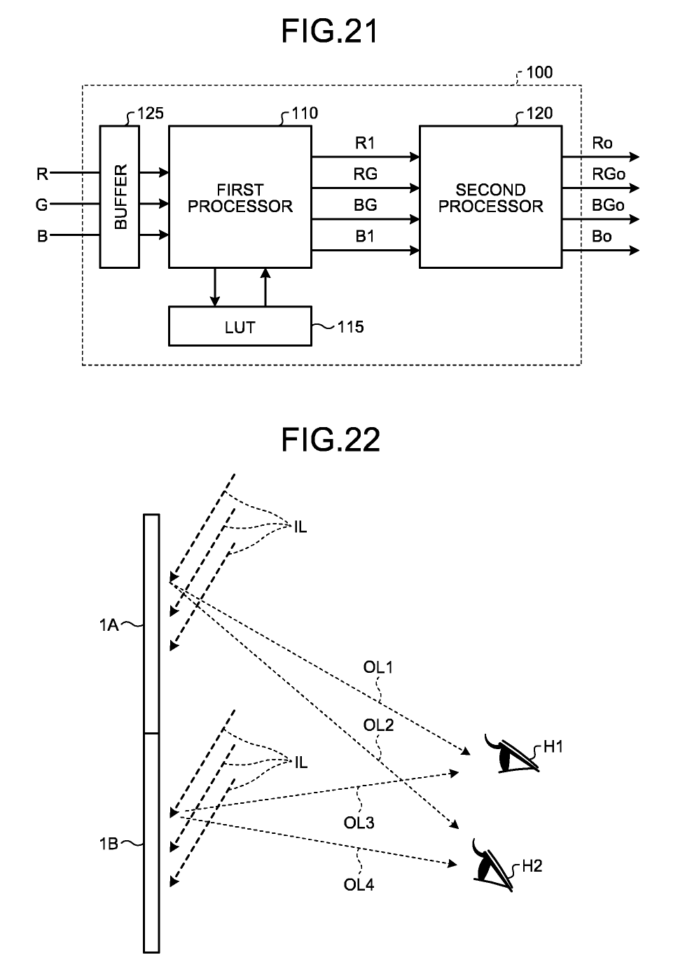

FIG. 21 is a block diagram illustrating an exemplary configuration of the signal processing circuit. The signal processing circuit 100 includes a first processor 110, a second processor 120, a look-up table (LUT) 115, and a buffer 125. The first processor 110 identifies the gradation values (R1, RG, BG, and B1) of the respective four sub-pixels 15 according to the input gradation values. The gradation value of “RG” out of the gradation values (R1, RG, BG, and B1) of the respective four sub-pixels 15 is the gradation value of the red green RG1. Specifically, “RG” corresponds to the peak of the spectrum of the light transmitted through the first color filter included in the first sub-pixel. The gradation value of “BG” is the gradation value of the blue green BG1. Specifically, “BG” corresponds to the peak of the spectrum of the light transmitted through the second color filter included in the second sub-pixel. The gradation value of “R1” is the gradation value of the red (R1), for example. Specifically, “R1” corresponds to the peak of the spectrum of the light transmitted through the third color filter included in the third sub-pixel. Furthermore, the gradation value of “B1” is the gradation value of the blue (B1), for example. Specifically, “B1” corresponds to the peak of the spectrum of the light transmitted through the fourth color filter included in the fourth sub-pixel.

The LUT 115 is table data including the information on the gradation values of the four respective sub-pixels 15 predetermined for the gradation values of R, G, and B. The following describes an example in which the LUT 115 determines the gradation value of each of the first sub-pixel 11, the second sub-pixel 12, the third sub-pixel 13, and the fourth sub-pixel 14 illustrated in FIG. 3. The first processor 110 refers to the LUT 115 and identifies the gradation values of (R1, RG1, BG1, and B1) corresponding to the input gradation values. For example, when the input gradation values are expressed as (R, G, B)=(n, n, n) as illustrated in FIG. 4, the first processor 110 refers to the LUT 115 and identifies the gradation values as (R1, RG1, BG1, B1)=(n1, n2, n3, n4), where (n1, n2, n3, n4) represent colors of the first sub-pixel 11, the second sub-pixel 12, the third sub-pixel 13, and the fourth sub-pixel 14 and are gradation values for reproducing colors corresponding to (R, G, B)=(n, n, n). The same applies to a case in which the input gradation values are other gradation values. When the input gradation values are expressed as (R, G, B)=(n, 0, 0), the first processor 110 identifies the gradation values as (R1, RG1, BG1, B1)=(n, 0, 0, 0). When the input gradation values are expressed as (R, G, B)=(0, n, 0), the first processor 110 identifies the gradation values as (R1, RG1, BG1, B1)=(0, n5, n6, 0). When the input gradation values are expressed as (R, G, B)=(0, 0, n), the first processor 110 identifies the gradation values as (R1, RG1, BG1, B1)=(0, 0, 0, n). When the input gradation values are expressed as (R, G, B)=(m, m, 0), the first processor 110 identifies the gradation values as (R1, RG1, BG1, B1)=(m1, m2, m3, 0). When the input gradation values are expressed as (R, G, B)=(0, m, m), the first processor 110 identifies the gradation values as (R1, RG1, BG1, B1)=(0, m4, m5, m6). When the input gradation values are expressed as (R, G, B)=(m, 0, m), the first processor 110 identifies the gradation values as (R1, RG1, BG1, B1)=(m7, 0, 0, m8).

The input gradation values input to the signal processing circuit 100 is stored and retained in the buffer 125. The buffer 125 stores the input gradation values associated with all or part of the pixel region constituting the input image. The first processor 110 applies the sub-pixel rendering described with reference to FIGS. 8, 10, and 13 to the identified input gradation values of the first sub-pixel 11, the second sub-pixel 12, the third sub-pixel 13, and the fourth sub-pixel 14 and corrects the gradation values of the sub-pixels 15 constituting each pixel.

The second processor 120 outputs to the signal output circuit 70 the area coverage modulation signals (Ro, RGo, BGo, and Bo) corresponding to the respective sub-divided pixels associated with the gradation values (R1, RG, BG, and B1) (e.g., R1, RG1, BG1, and B1) of the respective four sub-pixels 15. For example, when the gradation values of the colors of (R1, RG1, BG1, and B1) identified by the first processor 110 are 8-bit numeric values (0 to 255), the second processor 120 divides the 8-bit numeric values into 2^{N} for conversion into the corresponding N-bit gradation values. When N=3, for example, a correspondence relation between the N-bit gradation values (0 to 7) and the gradation values (0 to 255) to be taken by the 8-bit numeric values may be classified as follows: 0:0 to 31; 1:32 to 63; 2:64 to 95; 3:96 to 127; 4:128 to 159; 5:160 to 191; 6:192 to 223; and 7:224 to 255. The foregoing classification example assumes gradation values corresponding to a linear space of 0 to 1.0 in which the gradation values are not subjected to gamma correction. The classification may be different when the gamma correction is applied. The second processor 120 converts 8-bit gradation values of the colors of (R1, RG1, BG1, and B1) into corresponding N-bit gradation values in accordance with the correspondence relation. For example, the second processor 120 converts the gradation values of (R1, RG1, BG1, B1)=(10, 100, 200, 255) to the area coverage modulation signals of (Ro, RGo, BGo, Bo)=(0, 4, 6, 7), and outputs the signals to the signal output circuit 70. An area coverage modulation expression corresponding to the input gradation values is thereby performed.

FIG. 22 is a diagram schematically illustrating an exemplary relation among the external light IL, reflected light OL1, OL2, OL3, and OL4, and user's viewpoints H1 and H2 when a plurality of display devices 1A and 1B are disposed in juxtaposition. Each of the display devices 1A and 1B is the reflective display device in the embodiment (e.g., display device 1). The reflected light OL1, OL2, OL3, and OL4 represent beams of light OL having exit angles different from one another. As illustrated in FIG. 22, when the display devices 1A and 1B are disposed in juxtaposition, for example, beams of light OL having different exit angles from the display devices 1A and 1B may be viewed even with an incident angle of incident light IL on the display device 1A being identical to an incident angle of incident light IL on the display device 1B. In this case, with respect to the user's viewpoint H1, the reflected light OL from the display device 1A is the reflected light OL1, and the reflected light OL from the display device 1B is the reflected light OL3. Which of the reflected light OL1 or the reflected light OL2 from the display device 1A is viewed by the user is changed depending on which of the user's viewpoint H1 or the user's view point H2 is assumed. Similarly, which of the reflected light OL3 or the reflected light OL4 from the display device 1B is viewed by the user is changed depending on which of the user's viewpoint H1 or the user's view point H2 is assumed. Consequently, the exit angle of the light OL viewed by the user may vary depending on conditions, such as how the display devices 1A and 1B are disposed, and where the user's viewpoint is. Thus, the display device 1A may be configured differently from the display device 1B without departing from the scope of the present disclosure. For example, either one of the display devices 1A and 1B may be configured as illustrated in any one of FIGS. 3, 9, 11, and 12, and the other of the display devices 1A and 1B may be configured as illustrated in another of FIGS. 3, 9, 11, and 12. Alternatively, the correspondence relation between the input (gradation values of R, G, and B) and (R1, RG, BG, and B1) in the LUT 115 of the display device 1A may be made different from the correspondence relation between the input (gradation values of R, G, and B) and (R1, RG, BG, and B1) in the LUT 115 of the display device 1B.

A possible configuration may not employ sub-divided gradation or memory function. In this configuration, the potential difference between the reflective electrode 40 and the counter electrode 22 of the sub-pixel 15 without having the sub-divided pixels 50 is varied in an analog manner according to the gradation value. In this case, processing by the second processor 120 is omitted. The sub-pixel 15 without having the sub-divided pixels 50 has a configuration similar to that of the sub-divided pixel 50, and the area of the reflective electrode 40 and the size of an opening divided by the black matrix 23 are greater than those of the sub-divided pixel 50.

As described above, according to the embodiment, the first sub-pixel includes the third color filter that has a spectrum peak falling on the spectrum of reddish green. The second sub-pixel includes the fourth color filter that has a spectrum peak falling on the spectrum of bluish green. The third sub-pixel includes the first color filter that has a spectrum peak falling on the spectrum of red. The fourth sub-pixel includes the second color filter that has a spectrum peak falling on the spectrum of blue. The foregoing arrangements can further increase the luminance and saturation of yellow, thereby achieving the required luminance and saturation of yellow (e.g., yellow Y).

By setting the common positional relations among the sub-pixels 15 in the embodiment, reproduced colors including white can be obtained while having the color gravitational center to fall within a region of a single pixel through a combination of sub-pixels 15 disposed in a matrix form without the need to include the sub-pixels 15 of all colors in the single pixel. Specifically, the positional relations, in which the first sub-pixel is adjacent to the third sub-pixel in the X-direction, the second sub-pixel is adjacent to the fourth sub-pixel in the X-direction, the first sub-pixel is adjacent to the second sub-pixel in the Y-direction, the first sub-pixel is not adjacent to the third sub-pixel in the Y-direction, the first sub-pixel is not adjacent to the fourth sub-pixel in the Y-direction, the second sub-pixel is not adjacent to the third sub-pixel in the Y-direction, and the second sub-pixel is not adjacent to the fourth sub-pixel in the Y-direction, can reduce the number of sub-pixels 15 in a single pixel, while preventing deviation in the color gravitational center. Specifically, the positional relations can reduce constituent elements including a contact hole disposed in the black matrix 23 and the reflective electrode 40 that do not contribute to a reflection factor of the pixel. The configuration can readily enhance the brightness of the image displayed by the reflective display device.

The configuration in which, as illustrated in FIG. 9, the first sub-pixel 11A is adjacent to the second sub-pixel 12A in the X-direction, the third sub-pixel 13A is adjacent to the fourth sub-pixel 14A in the Y-direction, the first sub-pixel 11A is not adjacent to the fourth sub-pixel 14A in the X-direction, the second sub-pixel 12A is not adjacent to the third sub-pixel 13A in the X-direction, and the third sub-pixel 13A is not adjacent to the fourth sub-pixel 14A in the X-direction, can prevent deviation in the color gravitational centers 17c and 17d in the Y-direction in the sub-pixel rendering.

The first sub-pixel and the second sub-pixel in combination reproduce green. This configuration can allocate a greater area of color filters and reflective electrodes combining the first sub-pixel and the second sub-pixel out of the display region of a single pixel to the reproduction of green.

As in the examples illustrated in FIGS. 9, 11, and 13, in the X-direction, the third sub-pixel and the fourth sub-pixel are disposed in alternate positions and the first sub-pixel and the second sub-pixel are interposed between the third sub-pixel and the fourth sub-pixel. The foregoing arrangement can further increase an area of sub-pixels to be used for reproducing yellow, thereby making the yellow even more vivid.

A reflective display device operable with lower power consumption can be provided by the sub-divided pixels performing the area coverage modulation.

The sub-divided pixels each include a holder that holds a potential variable according to gradation expression. This configuration allows the reflective display device to further reduce power consumption.

The present disclosure can naturally provide other advantageous effects that are provided by the aspects described in the embodiments above and are clearly defined by the description in the present specification or appropriately conceivable by those skilled in the art.

What is claimed is:

1. A display device comprising:
a plurality of first sub-pixels each including a first color filter that transmits light having a spectrum peak falling on a spectrum of reddish green;
a plurality of second sub-pixels each including a second color filter that transmits light having a spectrum peak falling on a spectrum of bluish green;
a plurality of third sub-pixels each including a third color filter that transmits light having a spectrum peak falling on a spectrum of red; and
a plurality of fourth sub-pixels each including a fourth color filter that transmits light having a spectrum peak falling on a spectrum of blue, wherein
the first sub-pixels, the second sub-pixels, the third sub-pixels, and the fourth sub-pixels each include a reflective electrode that reflects light transmitted through the corresponding color filter,
one of the first sub-pixels is adjacent to one of the third sub-pixels in a first direction,
one of the second sub-pixels is adjacent to one of the fourth sub-pixels in the first direction,
the one of the first sub-pixels is adjacent to the one of the second sub-pixels in a second direction crossing the first direction,
none of the first sub-pixels is adjacent to the third sub-pixels in the second direction,
none of the first sub-pixels is adjacent to the fourth sub-pixels in the second direction,
none of the second sub-pixels is adjacent to the third sub-pixels in the second direction, and
none of the second sub-pixels is adjacent to the fourth sub-pixels in the second direction.

2. The display device according to claim 1, wherein
the one of the first sub-pixels is adjacent to the one of the fourth sub-pixels in the first direction,
the one of the second sub-pixels is adjacent to the one of the third sub-pixels in the first direction, and
none of the first sub-pixels is adjacent to the second sub-pixels in the first direction.

3. The display device according to claim 1, wherein
the one of the first sub-pixels is adjacent to another one of the fourth sub-pixels in the first direction,
the one of the second sub-pixels is adjacent to another one of the third sub-pixels in the first direction, and
none of the first sub-pixels is adjacent to the second sub-pixels in the first direction.

4. The display device according to claim 3, wherein none of the third sub-pixels is adjacent to the fourth sub-pixels in the first direction.

5. The display device according to claim 1, wherein
the one of the first sub-pixels is adjacent to another one of the second sub-pixels in the first direction,
none of the first sub-pixels is adjacent to the fourth sub-pixels in the first direction,
none of the second sub-pixels is adjacent to the third sub-pixels in the first direction, and
none of the third sub-pixels is adjacent to the fourth sub-pixels in the first direction.

6. The display device according to claim 1, wherein at least one of the first sub-pixels and at least one of the second sub-pixels in combination reproduce green.

7. The display device according to claim 1, wherein at least one of the first sub-pixels, at least one of the second sub-pixels, and at least of the third sub-pixels in combination reproduce yellow.

8. The display device according to claim 1, wherein each of the third sub-pixels and each of the fourth sub-pixels are greater in size than each of the first sub-pixels and each of the second sub-pixels.

9. The display device according to claim 2, wherein each of the third sub-pixels and each of the fourth sub-pixels have a width in the second direction greater than a width in the second direction of each of the first sub-pixels and a width in the second direction of each of the second sub-pixels.

10. The display device according to claim 1, wherein a region combining three out of each of the first sub-pixels, each of the second sub-pixels, each of the third sub-pixels, and each of the fourth sub-pixels has a square shape.

11. The display device according to claim 4, wherein a region combining two sub-pixels adjacent to each other in the first direction out of each of the first sub-pixels, each of the second sub-pixels, each of the third sub-pixels, and each of the fourth sub-pixels has a square shape.
